(19) United States
(12) Patent Application Publication
(10) Pub. No.: US 2022/0284495 A1
(43) Pub. Date: Sep. 8, 2022

(54) SYSTEM AND METHOD FOR OBTAINING LIVE INTERACTIVE ADVICE REGARDING PRODUCTS UPON REQUEST

(71) Applicant: EYEZON PTE. LTD., Singapore (SG)

(72) Inventors: Dragorad Knezi, Sombor (RS); Anton Lubohinets, Brest (BY); Vladislav Klimuk, Brest (BY); Luibov Tuz, Korolev (RU)

(21) Appl. No.: 17/826,125

(22) Filed: May 26, 2022

Related U.S. Application Data
(63) Continuation-in-part of application No. 17/266,974, filed on Feb. 8, 2021.

(30) Foreign Application Priority Data
Feb. 14, 2020 (RU) 2020107043

(51) Int. Cl. G06Q 30/06; H04N 21/2187

(52) U.S. Cl. CPC G06Q 30/0623; G06Q 30/0643; H04N 21/2187

(57) ABSTRACT

A system (and method) for providing information is presented. The system operates during remote, online purchasing (selling) of goods and (or) services, namely, by adding an option for a live video broadcast in real time at a user request to a graphics, photos, or text description of an object or place provided on the product webpage of any online platform (site). A live video broadcasting seeking additional information regarding an item (product or service) is carried out on the same webpage of the site where the graphic or text description thereof is provided, without going over and using other services or tools for exchanging video, audio or text messages, and also without using video call tools or services.

### CROSS-REFERENCE TO RELATED APPLICATIONS

This application is a continuation-in-part of U.S. patent application Ser. No. 17/266,974 filed on Feb. 8, 2021, which is a US national stage under 35 USC 371 of PCT/RU2020/000290 filed on Jun. 17, 2020, which claims priority to Russian application no. 2020107043 filed on Feb. 14, 2020. The entire content of these applications is incorporated by reference herein.

### FIELD OF THE INVENTION

The present inventions relate to a system and method of on demand live video presentation of product or service information.

### BACKGROUND OF THE INVENTION

Online customers purchase different goods and services by browsing static, previously prepared text, pictures, and videos of the products and services on the sellers' websites. Very often online customers have questions which are not answered in the descriptions and pictures on the website. If customers were in a physical brick and mortar store a sales person could answer their questions. However, online customers do not have this option and could only call a customer service number to have a voice conversation without an opportunity to see the additional live pictures of the product in question and the sales person. Doing so requires customers to take out their smartphones, find a customer service number, dial this number, wait on hold, and finally speak with a customer service representative and initially having to tell her what the product or service the customer is interested in, its SKU or another identifier, and the customer's question. This is a very cumbersome and time consuming procedure which discourages customers from getting the additional needed information.

### SUMMARY OF THE INVENTION

Different embodiments of the system and method of this invention solve this prior art problem by providing on demand live video broadcast in real time between a prospective purchaser/customer and a sales person which the purchaser could request on the same webpage of the product or service the purchaser was viewing. A live video broadcasting seeking additional information regarding an item (product or service) is carried out on the same product webpage without going over and using other devices, services or tools for exchanging video, audio or text messages, and also without using video call tools or services such as Skype.

Various embodiments provide the advantages and features of the method for providing information of the present invention. In one embodiment a method comprises entering on a user device a setup request on a webpage associated with a product; receiving the setup request regarding the product at a server; searching a database for streamers for the product wherein the database includes at least one streamer who is a previous purchaser of the product; identifying the at least one streamer for the product who is a previous purchaser of the product; providing to the user an interface for entering a request for information; entering a request for information regarding the product through the interface; sending the request for information to the server; receiving the request for information by the server; forwarding the request for information to the at least one streamer for the product; receiving the request for information on a device of the at least one streamer for the product; receiving a decision from the at least one streamer for the product whether to accept or reject the request for information; if the at least one streamer for the product accepts the request for information, processing the request for information, receiving a selection of a live broadcast option from the at least one streamer for the product, turning on a camera on the device of the at least one streamer for the product, sending a request for a live broadcast channel from the server to a broadcast server, establishing the live broadcast channel by the broadcast server, transmitting a link to the live broadcast channel to the server from the broadcast server, transmitting the link to the live broadcast channel to the user device from the server, connecting the user device to the live broadcast channel through the link; establishing video and audio communication between the user and the at least one streamer for the product through the live broadcast channel; receiving an array of cursor coordinates corresponding to a position of an object drawn by the user on a screen of the user device. In this embodiment of the method, entering on a user device a setup request on a webpage associated with a product comprises pressing a button on the webpage. In this embodiment of the method, entering a request for information comprises pressing a button on the webpage. In this embodiment of the method, the product comprises a service. In this embodiment of the method, the webpage associated with a product comprises a mobile application page. In this embodiment of the method, the live broadcast channel between the user and the at least one streamer for the product is capable to communicate at least one of photo files, audio files, video files, or live audio and video broadcasting. In this embodiment of the method, the connecting the user device to the live broadcast channel through the link comprises opening up a new browser window on the user device. In this embodiment of the method, the connecting the user device to the live broadcast channel through the link further comprises turning on a camera and microphone on the user device. In this embodiment of the method, the request for information comprises a text message, an email, or an SMS message. In this embodiment of the method, the request for information comprises a request for advice. In this embodiment of the method, the webpage associated with a product is a webpage of an online store. In this embodiment of the method, the receiving the request for information on a device of the at least one streamer for the product comprises receiving a push notification on a device of the at least one streamer for the product. In this embodiment the method further comprising turning push notification on the user device and providing email address of the user. In this embodiment the method further comprising turning push notification on the user device. In this embodiment of the method, the interface for entering a request for information comprises a pop-up window. In this embodiment of the method, the interface for entering a request for information comprises a text or audio communication channel. In this embodiment of the method, the establishing video and audio communication between the user and the at least one streamer for the product through the live broadcast channel is performed in the interface. In this embodiment the method further comprising receiving a response from the at least one streamer for the product to the information request via email message. In this embodiment the method further comprising recording video and audio communications between the user and the at least one streamer for the product through the live broadcast channel. In this embodiment the method further comprising an add-to-cart button placed in the live broadcast channel or the interface wherein both the user and the at least one streamer could click in order to purchase the product. In this embodiment the method further comprising adding to the database a first streamer who is registered as a streamer with at least two separate sellers.

Another embodiment provides a system for providing information comprising a streaming server; a database communicatively coupled to the streaming server; and a server communicatively coupled to the streaming server, the server configured with a non-transitory computer readable medium having stored thereon computer instructions, which upon execution by a central processing engine, cause the central processing engine to execute one or more applications for providing information comprising: receiving at the server a setup request regarding a product on a webpage associated with the product entered on a user device; searching the database for streamers for the product wherein the database includes at least one streamer who is a previous purchaser of the product; identifying the at least one streamer for the product who is a previous purchaser of the product; providing to the user device an interface for entering a request for information; receiving by the server a request for information regarding the product entered on the user device through the interface; forwarding the request for information to the at least one streamer for the product; receiving the request for information on a device of the at least one streamer for the product; receiving a decision from the at least one streamer for the product whether to accept or reject the request for information; if the at least one streamer for the product accepts the request for information, processing the request for information, receiving a selection of a live broadcast option from the at least one streamer for the product, turning on a camera on the device of the at least one streamer for the product, sending a request for a live broadcast channel from the server to the streaming server, establishing the live broadcast channel by the streaming server, transmitting a link to the live broadcast channel to the server from the streaming server, transmitting the link to the live broadcast channel to the user device from the server, connecting the user device to the live broadcast channel through the link; establishing video and audio communication between the user and the at least one streamer for the product through the live broadcast channel; receiving an array of cursor coordinates corresponding to a position of an object drawn by the user on a screen of the user device.

Yet another embodiment provides a method for providing information comprising entering on a user device a setup request on a webpage associated with a product; receiving the setup request regarding the product at a server; searching a database for streamers for the product wherein the database includes at least one streamer who is a previous purchaser of the product; identifying the at least one streamer for the product who is a previous purchaser of the product; providing to the user an interface for entering a request for information; entering a request for information regarding the product through the interface, wherein the request for information comprises a request for a guest to join the user; sending the request for information to the server; receiving the request for information by the server; forwarding the request for information to the at least one streamer for the product; receiving the request for information on a device of the at least one streamer for the product; receiving a decision from the at least one streamer for the product whether to accept or reject the request for information; if the at least one streamer for the product accepts the request for information, processing the request for information, receiving a selection of a live broadcast option from the at least one streamer for the product, turning on a camera on the device of the at least one streamer for the product, sending a request for a first and a second live broadcast channels from the server to a broadcast server, establishing the first and the second live broadcast channels by the broadcast server, transmitting a first link to the first live broadcast channel to the server from the broadcast server, transmitting a second link to the second live broadcast channel to the server from the broadcast server, transmitting the first link to the first live broadcast channel to the user device from the server, connecting the user device to the first live broadcast channel through the first link; establishing video and audio communication between the user and the at least one streamer for the product through the first live broadcast channel; transmitting a second link to the second live broadcast channel to the user device from the server, connecting a computing device of the guest to the second live broadcast channel through the second link, establishing video and audio communication between the guest, the user and the at least one streamer for the product through the first live broadcast channel and the second live broadcast channel; receiving an array of cursor coordinates corresponding to a position of an object drawn by the user on a screen of the user device.

Yet another embodiment provides a method for providing information comprising providing to a user on a user device an interface for entering a request for information on a webpage associated with a product; obtaining user contact information comprising one or more of an email address, a phone number, a name, and a physical street address; entering a request for information regarding the product through the interface; sending the request for information to a server; receiving the request for information by the server; searching a database for streamers for the product wherein the database includes at least one streamer who is a previous purchaser of the product; identifying the at least one streamer for the product who is a previous purchaser of the product; forwarding the request for information to the at least one streamer for the product; receiving the request for information on a device of the at least one streamer for the product; receiving a decision from the at least one streamer for the product whether to accept or reject the request for information; if the at least one streamer for the product accepts the request for information but the user closes the interface before a live broadcast channel with the at least one streamer was established, recording a video presentation regarding the product by the at least one streamer for the product; delivering the video presentation to the user by using the user contact information.

Yet another embodiment provides a method for providing information comprising receiving a request for information regarding a product through a user scanning a QR-code by a user device; sending the request for information to a server; receiving the request for information by the server; searching a database for streamers for the product wherein the database includes at least one streamer who is a previous purchaser of the product; identifying the at least one streamer for the product who is a previous purchaser of the product; forwarding the request for information to the at least one streamer for the product; receiving the request for information on a device of the at least one streamer for the product; receiving a decision from the at least one streamer for the product whether to accept or reject the request for information; if the at least one streamer for the product accepts the request for information, processing the request for information, receiving a selection of a live broadcast option from the at least one streamer for the product, turning on a camera on the device of the at least one streamer for the product, sending a request for a live broadcast channel from the server to the streaming server, establishing the live broadcast channel by the streaming server, transmitting a link to the live broadcast channel to the server from the streaming server, transmitting the link to the live broadcast channel to the user device from the server, connecting the user device to the live broadcast channel through the link; establishing video and audio communication between the user and the at least one streamer for the product through the live broadcast channel. In this embodiment of the method, the user scanning a QR-code by a user device further comprises scanning the QR-code placed in an advertisement, a video, a mobile application, a webpage, or a publication.

Yet another embodiment provides a method for providing information comprising receiving a request for information from a user on a device of a streamer for a product; sending a decision from the streamer for the product whether to accept or reject the request for information; if the streamer for the product accepts the request for information, sending a selection of a live broadcast option from the streamer for the product, conducting a video and audio communication between the user and the streamer for the product through a live broadcast channel.

### BRIEF DESCRIPTION OF THE DRAWINGS

The teachings of different embodiments of the present invention can be readily understood by considering the following detailed description in conjunction with the accompanying drawings of the various embodiments of the invention, in which:

FIG. 1 schematically depicts a system of one embodiment of the present invention;

FIG. 2 is a schematic depiction of major components of a server in one embodiment of the present invention;

FIG. 3 is a flow chart of the steps performed to set up a client account of the system in one embodiment of the present invention;

FIG. 4 depicts an exemplary excerpt of information stored by the system 100 for a client account;

FIG. 5 depicts an exemplary excerpt of information stored by the system 100 for a streamer account;

FIG. 6 depicts an exemplary excerpt of information stored by the system 100 for a video request button 140;

FIG. 7 depicts an exemplary excerpt of information stored by the system 100 for a stream;

FIG. 8 is a flow chart of the steps performed in one embodiment of the present invention to conduct a live video broadcast;

FIG. 8a is a flow chart of the steps performed in one embodiment of the present invention to conduct a live video broadcast;

FIGS. 9, 9A, 9B, and 9C are a flow chart of alternative steps performed in one embodiment of the present invention to conduct a live video broadcast;

FIG. 10 is a schematic depiction of the operation of one module of one embodiment of the present invention;

FIG. 11 schematically depicts a system of one embodiment of the present invention; and

FIGS. 12, 12A, 12B, and 12C are a flow chart of the steps performed in one embodiment of the present invention.

### DETAILED DESCRIPTION OF THE INVENTION

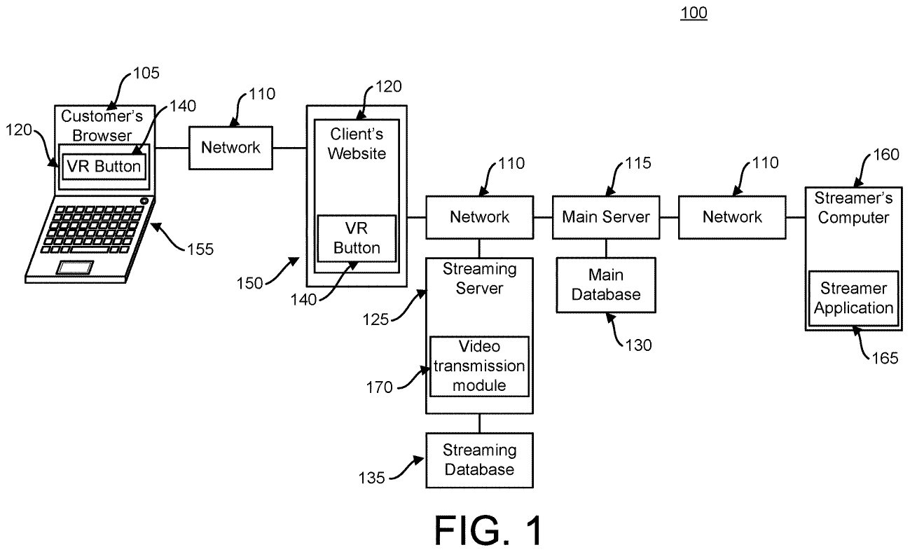

Referring to FIG. 1, an embodiment of the online broadcasting system 100 of the present invention is schematically depicted. It comprises a main server 115 connected to a main database 130, a streaming server 125 connected to the main server 115 via a network 110 and also connected to a streaming database 135. The system 100 creates and places a video request button 140 on some or all webpages or mobile application pages which describe certain goods or services regarding which the seller is interested in conducting live online broadcasts. These webpages are part of a website of a client of the system, who is typically a seller of some merchandise or services. Client's website 120 consisting of at least one webpage, and typically of multiple webpages, is hosted on a client server 150. A prospective purchaser, often referred to as a customer or user, from her computer 155 opens an Internet browser 105 and opens the client website 120, at least one webpage of which has the video request button 140 on it. The computer 155, which could be any computing device such as a laptop, desktop, server, smartphone, tablet, etc., is connected via the network 110 with the client server 150. A streamer computer 160, which could be any computing device such as a laptop, desktop, server, smartphone, tablet, etc., is connected to the main server 115 via the network 110. A streamer application 165 is stored and later runs on the streamer computer 160. A video transmission module 170 is stored and later runs on the streaming server 125.

Clients of the system are typically retailers, manufacturers, distributors, online retailers or marketplaces, or service providers (such as travel agencies, charities, nonprofit organizations, etc.) which typically offer for sale/purchase to the consuming public some merchandise or services. Clients of the system desire to enhance the online purchasing experience of their prospective purchasers by offering them an opportunity for a live video conversation with a sales representative knowledgeable about a product or service which the potential purchaser is interested in. Clients of the system typically have multiple sales representatives, who could be their employees, freelancers, independent contractors, etc., who are available to answer prospective purchasers' question over a live video stream regarding one or more product or service of the client seller.

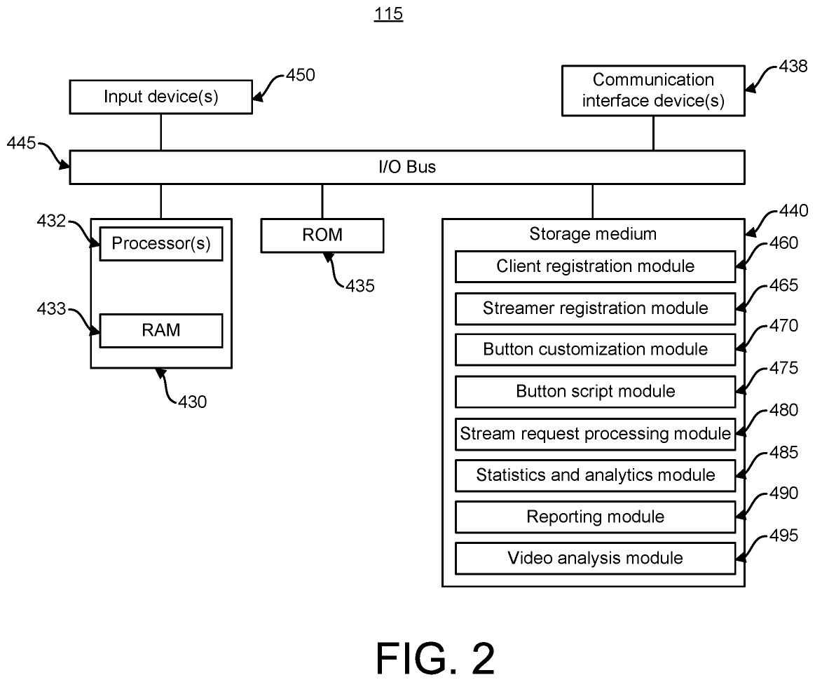

Referring to FIG. 2, the main server 115 may be a special purpose or a general purpose computer in some embodiments. The main server 115 comprises at least one processing unit 430 which comprises one or more processors 432 and random access memory (RAM) 433. They are electronically connected to other components of the main server 115 through the input/output bus 445. The main server 115 is capable of receiving signals from at least one input device 450, which could comprise a keyboard, a mouse, a touch input screen, or an audio recognition device, etc., and is electronically connected to it through the input/output bus 445. At least one storage medium 440, which is also electronically connected to other components of the main server 115 through the input/output bus 445, stores different software programs and instructions, including client registration module 460, streamer registration module 465, button customization module 470, button script module 475, stream request processing module 480, statistics and analytics module 485, reporting module 490, and other data.

The one or more processors 432 may be in a form of a central processing unit (CPU); a multi-processor unit (MPU); an ARM processor; a controller; a programmable logic device; or a similar device. In some embodiments, the at least one processing unit 430 includes one or more processors operatively connected to one or more of a RAM, ROM, and machine-readable storage medium. The one or more processors of the at least one processing unit 430 receive instructions stored by the one or more of a RAM, ROM, and machine-readable storage medium via a bus, and the one or more processors execute the received instructions. In some embodiments, the at least one processing unit 430 is an ASIC (Application-Specific Integrated Circuit) or a SoC (System-on-Chip). Examples of the at least one input device 450 include tactile devices such keyboards, keypads, foot pads, touch screens, and/or trackballs; non-contact devices such as audio input devices; motion sensors and motion capture devices that the main server 115 can use to receive inputs from a client or another user, when the client interacts with the main server 115; physiological sensors that monitor the physiology of the user; environmental sensors, accelerometers, or location sensors that monitor the physical environment of the main server 115.

The communication interface devices 438 provide one or more wired or wireless interfaces for communicating data and commands between the main server 115 and other devices that may be included in the online broadcasting system 100. Such wired and wireless interfaces include, but are not limited to: a Universal Serial Bus (USB) interface, a Bluetooth interface, a Wi-Fi interface, an Ethernet interface, a Near Field Communication (NFC) interface, a plain old telephone system (POTS) interface, a cellular or satellite telephone network interface, and the like.

In various embodiments, the at least one machine-readable storage medium 440 is one of a (or a combination of two or more of) a hard drive, a flash drive, a DVD, a CD, a flash storage, a solid state drive, a ROM, an EEPROM, and the like, and removable media such as, but not limited to, a USB memory device, an optical CD ROM, magnetic media such as tape and disks, and the like.

The at least one machine-readable storage medium 440 stores machine-executable instructions for various components of the main server 115, such as but not limited to: an operating system, one or more device drivers, one or more application programs including but not limited to an interactive application, and software modules and data for use by the one or more processors 432 to provide the features of a controller as described herein. In operation, the machine-executable instructions are loaded into RAM 433 from the at least one machine-readable storage medium 440, the ROM 435 or any other storage location. The respective machine-executable instructions are accessed by the one or more processors 432 via the bus 445, and then executed by the one or more processors 432. Data used by the one or more processors 432 are also stored in RAM 433, and the one or more processors 432 access such data during execution of the machine-executable instructions. Execution of the machine-executable instructions causes the one or more processors 432 to control the main server 115 to provide the features as described herein.

Network 110 may be the Internet, LAN, WAN, Ethernet or other network. Other computing devices in the online broadcasting system 100 such as the streaming server 125, the streaming database 135, the client server 150, the customer computer 155, the streamer computer 160, etc. all have one or more of the components of the main server 115 as depicted and described in FIG. 2.

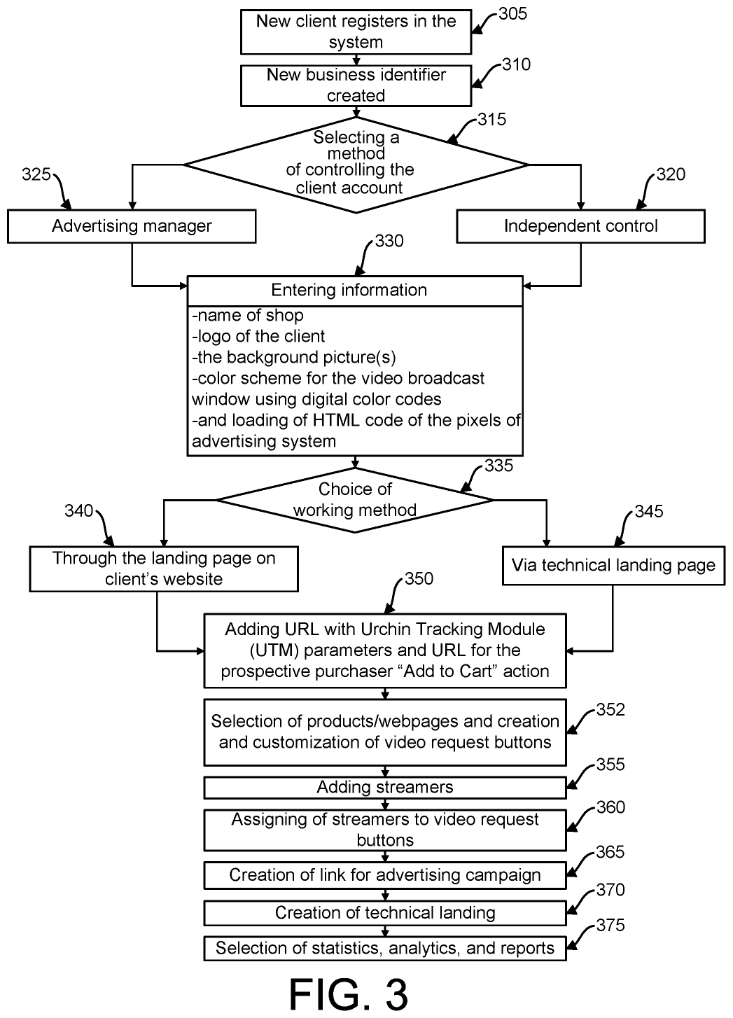

Referring to FIG. 3, the schematic operation and function of the client registration module 460 is depicted. At step 305 a new client registers in the system. At step 310, a new business identifier and client account is created for this new client by the client registration module 460. At step 315, the client registration module 460 prompts the client to select a method of controlling the client account either independent control at step 320 or advertising manager 325. At step 330, the client registration module 460 prompts the client to enter and select certain features and information for the system to use when providing this service to prospective purchasers of the client. In one embodiment, this could be the name of the store, website URL of the online store, logo of the client, the background picture(s), Favicon, color scheme for the video broadcast window using digital color codes, and loading of HTML code of the pixels of advertising systems. Other additional information and features could be entered or selected at this step, including brand name, payment information, service plan information (whether the client pays for each stream or has a monthly subscription for a number of streams), contact details of the client. At step 335, the client registration module 460 prompts the client to select a webpage where the online live broadcast (or streaming) window will open: either on the client's website, which is choice 340, or on a special landing website/webpage, which is choice 345.

At step 350, the client registration module 460 prompts the client to add URL with Urchin Tracking Module (UTM) parameters and URL for the prospective customer “Add to Cart” action. The UTM parameters are URL parameters used by marketers to track the effectiveness of online marketing campaigns across traffic sources and publishing media. The UTM parameters in a URL identify the campaign that refers traffic to a specific website. When a hyperlink contains a URL with UTM parameters, the web analytics software of the destination website interprets the parameter information and attributes the browser's website session and the sessions after that, until the campaign attribution window expires, to it. The UTM parameters can be parsed by analytics tools and used to populate reports. To define and append the relevant UTM parameters to the appropriate URLs, marketers routinely use simple, spreadsheet-based, or automated UTM builder tools such as including the Google Analytics URL Builder for websites. The UTM parameters include:

utm_source, which identifies which site sent the traffic, and is a required parameter;
utm_medium, which identifies what type of link was used, such as cost per click or email;
utm_campaign, which identifies a specific product promotion or strategic campaign;
utm_term, which identifies search terms;
utm_content, which identifies what specifically was clicked to bring the user to the site, such as a banner ad or a text link. It is often used for AB testing and content-targeted ads. The UTM parameters can be parsed by analytics tools and used to populate reports. Additional or different tracking mechanisms could be used by the client.

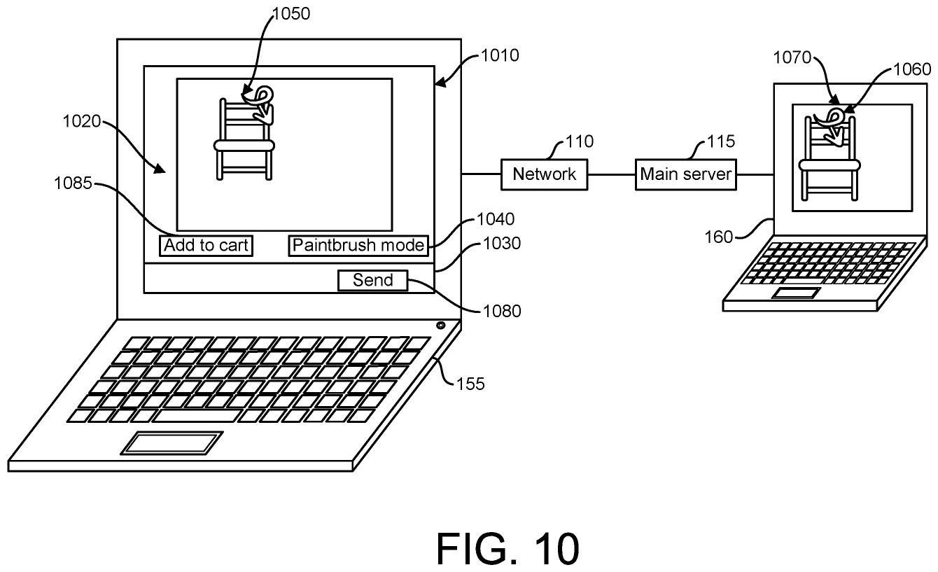

At step 352, the client registration module 460 prompts the client to select which products and webpages on its website would have the video request button 140 and to create and customize each video request button separately or collectively. This is accomplished by executing the button customization module 470. This customization includes selecting the color and shape for the video request button 140, the language in which the caption of the button 140 and other messages will be shown, an internal name or alias for this button for internal client reference, text of the greeting shown to the prospective purchaser when the purchaser clicks on the video request button 140, text for the text communication box such as “Please enter your question,” selecting sample pre-typed questions for the purchaser to choose from such as “Need more information regarding customization?” “Is this product available in a different color?” etc., selecting position(s) of different notices from the system to the purchaser, selecting what information/picture/text would be shown to the purchaser while the system is preparing for the stream after the prospective purchaser has clicked the video request button 140, e.g., a mini video game could be offered to the purchaser who is waiting for the requested stream to begin, and a countdown timer could be shown to let the purchaser know how soon the stream will begin, selecting what notification(s) are given to the prospective purchaser that the streamer is available to begin the live video broadcast—in the streaming browser window on the same product webpage, via a text SMS message or a messenger such as WhatsApp, by email, etc. This customization of the video request button(s) also may include customizing a form for the prospective purchaser to enter her personal information such as name, phone number, and email address if the client desires to request such information from the purchaser; whether to add an “Add to Cart” button to be displayed during the live video broadcast so the prospective purchaser could buy the product during a stream; where to place an icon which is created when the prospective purchaser, while waiting for the stream to begin, closes a video stream window 1010 (in FIG. 10), which icon upon the streamer's starting the stream notifies the prospective purchaser about that; etc. For certain clients which typically need more time to arrange for an available streamer to conduct a stream, such as auto dealers who need time for the sales person to get from the office to the remote lot where a particular car is, or real estate brokerages which need time for their sales person to get to the house or apartment of interest to the purchaser, the client could select an option to schedule a stream at a later time. The button customization module 470 then creates the video request buttons 140, places them on the selected webpages, and connects them to the button script module 475, which processes the prospective purchaser's click on the video request button 140.

At step 352, the button customization module 470 also prompts the client to customize or assign certain actions to be performed upon receiving notice that various events have happened. For example, upon a prospective purchaser clicking on the video request button 140, the button script module 475 generates an event BUTTON_CLICKED and the client could customize what it wants the system to do in reaction to this event (in addition to the normal flow of operations of the system). For example, one client may want to have a special message displayed to the prospective purchaser saying “We love you!!!”, and another client may want to show a short action video to the prospective purchaser upon getting notice of the BUTTON_CLICKED event. It should be noted that, whether or not client customization is available for a particular event and regardless of whether such customization was done, the button script module 475 sends all events, including an event BUTTON_CLICKED, to the statistics and analytics module 485 for recording and processing.

Other customization of the video request button 140 could also be done through an API, which have priority over customization done manually, and customizations specified initially at the account set up stage. For example, using an API method a language for the live video broadcast could be set by using the command eyeZon (‘setLanguage’, ‘EN’). The API method could also be used to set the position of the minimized icon, which by default is set to Bottom_Right, by using the following command

eyeZon(’setPosition’, ’BOTTOM_CENTER’) ;
enum Position { BOTTOM_LEFT = ’BOTTOM_LEFT’,
BOTTOM_CENTER = ’BOTTOM_CENTER’,
BOTTOM_RIGHT = ’BOTTOM_RIGHT’,
MID_LEFT = ’MID_LEFT’,
MID_CENTER = ’MID_CENTER’,
MID_RIGHT = ’MID_RIGHT’ }

The API method could also be used to set the opening of the video stream window 1010 upon an occurrence of a different event by using the following command

eyeZon(’open’, { target: ’Test’, title: ’Test’, ’buttonId’:
’5e81cf891cb513002ed6f3ab’ });

where “target” is a unique identifier of the stream (If it is not set, by default it would be set to the current URL), “title” is the product name regarding which the prospective purchaser desires to talk to the streamer, “buttonid” is used for customization and routing of the events to appropriate streamers, and is a parameter using which any occurrence could trigger opening of the video stream window 1010 and not just a click on the video request button 140.

Customization is also possible by using init commands to manually program and customize the system, for example,

eyeZon(’init’, {
businessId: ’5e81cf421cb513002ed6f39e’,
live: false,
position: ’BOTTOM_RIGHT’,
language: ’RU’,
fallbackLanguage: ’RU’,
hideEyeAfterMinutes: 24 * 60,
hideInputIfPossible: false,
logging: false,
unclosable: false });

Where the following parameters are used: “businessId” is a unique client identifier and is used to connect to the buttonId parameter; “live” is used to dynamically control the opening of the video stream window 1010 based upon certain occurrences other than a click on the video request button 140 such as opening a product webpage, etc.; “position” sets the placement of the minimized icon on the screen; “language” specifies the language to be used during the stream and if it is not specified the system could set the language to the browser of the product webpage language; “fallbacklanguage” is used when the stream cannot be conducted in the requested language; “hideEyeAfterMinutes” specifies the time after which the minimized icon would disappear after all the notices have been reviewed and by default it is set to 24 hours; “hideInputIfPossible” parameter is set to prevent the text box portion 1030 from opening so that the prospective purchaser cannot write her own questions and has to choose from pre-selected ones, which makes it easier for the streamers; “logging” triggers creation of a log of all error messages generated by the system which helps the client at the set up and testing stage; “unclosable” prevents the close button “x” from being displayed in the video stream window 1010 and thus prevents the prospective purchaser from ever closing it, which is a useful feature when the prospective purchaser does not need to close the video stream window 1010 such as when she opened it by scanning a QR code and the webpage has nothing but the video stream window 1010.

At step 355, the client registration module 460 prompts the client to add streamers or sales representatives who will conduct live video streaming with prospective purchasers to the client account. This is accomplished by executing the streamer registration module 465. For each streamer the client adds the following information and fields (which may be filled in with information later): name, address, email, phone number, URL, personal identification number, hours of availability to conduct streams, products and services which the streamer could cover in the streams, statistics and analytics section (which typically contains the counter of requested streams (or how many times have potential purchasers clicked on the video request button 140), counter of inactive purchasers (when after an initial click on the video request button 140 prospective purchaser had no follow on activity), counter of accepted streams, counter of completed streams, counter of streams which resulted or led to a purchase, purchasers' reviews of the streamer, average duration of completed streams, average time until stream request is accepted; breakdown of completed streams by different periods of the day, different geographies, different demographics of prospective purchasers, etc.), etc. These statistics, analytics, and reports are created by executing the statistics and analytics module 485 and the reporting module 490. At step 360, the client registration module 460 prompts the client to assign one or more streamers to each video request button 140. At step 365, the client registration module 460 prompts the client to create an advertising campaign, including the following information: campaign name, campaign manager, user-defined tags (for example #electronics #fall2021). At step 370, the client registration module 460 prompts the client to create a special landing page where the online live broadcast (or streaming) window will open which is different from the client's website, which could be used if the client made the choice 345.

At step 375, the client registration module 460 prompts the client to select the statistics, analytics, and reports that the system would periodically compile and produce for the client. Such statistics, analytics, and reports typically include a counter of requested streams (or how many times have potential purchasers clicked on the video request button 140), counter of inactive purchasers (when after an initial click on the video request button 140 prospective purchaser had no follow on activity), counter of accepted streams, counter of completed streams, counter of streams which resulted or led to a purchase, purchasers' reviews of the streamers, average duration of completed streams, average time until stream request is accepted; breakdown of completed streams by different periods of the day especially between working hours and non-working hours, different geographies, different demographics of prospective purchasers, etc.; recordings of the streams; etc. All such counters and statistics could be presented on the aggregate level as well as by each individual streamer, product, etc. These statistics, analytics, and reports are created by executing the statistics and analytics module 485 and the reporting module 490. These statistics, analytics, and reports are available in the client's account by selections on a dashboard as text and graphics, charts, etc., and they could be exported as a spreadsheet, such as MS Excel, for use by other software. This enables the clients to import some or all of the information available to them in their accounts regarding live video broadcasts into the client's own software systems to be combined with the client's other data for more robust and comprehensive analysis. The client could also import some of its data held outside of its broadcasting account into the broadcasting account for more robust and comprehensive analysis. In some embodiments of the present invention, system 100 is capable of analyzing recordings of the live video streams and providing reports and statistics regarding these streams. For example, the video analysis module 495 is capable of performing the following analysis: video length, speech to text conversion and analysis, matching video with spoken and typed words and prospective purchaser's actions (e.g., clicking the add to cart button 1085 or using a virtual paintbrush tool to draw on the computer screen), image and sound quality assessment, image analysis (which tells which colors, objects, bar codes, QR codes, etc. were shown), and other quality control parameters to evaluate the streamer's sales performance and the prospective purchaser's reaction.

In one embodiment, such client account dashboard could present statistics and analytics in different views. For example, one being a current period's statistics (a week, two week, a month, etc.) of number of requested streams, acceptance rate, streams conducted and their average duration and wait times until the stream request is accepted and until the stream is started. All information could be filtered by one or more video request buttons 140 which means they could be filtered by each product for which video broadcasting is available, and/or filtered by dates, etc. Another view on the dashboard and otherwise could be a comparative view where the same items and their statistics are presented in comparison between two different time periods. For example, current week and previous week.

When the client has an update to make to its account, it also logs into its account and the client registration module 460 prompts the client to make desired changes and updates. For example, the client could add or delete a streamer, change text on a particular video request button, add or delete a product for streaming, change periodic reports, etc.

It should be noted that, the system of one embodiment of the present invention uses a variety of events regarding various aspects of the prospective purchaser and streamer interactions before, during, and after a stream to analyze performance and create statistical reports regarding streams. Accordingly, the button script module 475 sends all events to the statistics and analytics module 485 for recording and processing.

For example, upon a prospective purchaser clicking on the video request button 140, the button script module 475 generates an event BUTTON_CLICKED and sends it to the statistics and analytics module 485. In addition, for some events, client customization is available. For example, the button customization module 470 prompts the client to customize or assign certain actions to be performed upon receiving notice that various events have happened. For example, upon a prospective purchaser clicking on the video request button 140, the button script module 475 generates an event BUTTON_CLICKED and the client could customize what it wants the system to do in reaction to this event (in addition to the normal flow of operations of the system). For example, one client may want to have a special message displayed to the prospective purchaser saying “We love you!!!”, and another client may want to show a short action video to the prospective purchaser upon getting notice of the BUTTON_CLICKED event.

If after the prospective purchaser clicked the video request button 140, the stream request processing module 480 did not find at least one presently available streamer to conduct a live video broadcast with the prospective purchaser, a PASSIVE_REQUEST event is generated and sent to the statistics and analytics module 485.

If after the prospective purchaser clicked the video request button 140, and the stream request processing module 480 found at least one presently available streamer to conduct a live video broadcast with the prospective purchaser but such streamer for a variety of reasons could not start a stream within the predetermined wait time (for example, 2 minutes), a MISSED_REQUEST event is generated. The button script module 475 then offers the prospective user to subscribe to notifications regarding when the streamer is available or to schedule a stream at another time.

Upon the prospective purchaser entering a question or request in the text box portion 1030 of the video stream window 1010 (as shown in FIG. 10), the button script module 475 generates an event STREAM_CREATED and adds streamId parameter to it. Certain parameters or data may be included with the events. For example, if the prospective purchaser clicks on a predefined/pretyped question a predefinedMessageIndex and predefinedMessage parameters are added to this event. If the prospective purchaser simply clicked on the video request button 140 but did not submit a question or a request, this event STREAM_CREATED is not generated. For example, this event could be implemented in one embodiment as follows:

```
    eyeZon(‘on’, ‘DIALOG_CREATED’, function(data) {
        if (data.predefinedMessageIndex === 0) {
  console.log(‘DIALOG_CREATED1’, data);
      } else if (data.predefinedMessageIndex === 1) {
          console.log(‘DIALOG_CREATED2’, data);
      }
  else
  {console.log(‘DIALOG_CREATED3’, data);
  }
  })
  The following is an example of one way of using the event STREAM_CREATED in one
embodiment of the present invention
  <script>
      (function (w,d,s,o,f,js,fjs) {
            w[o] = w[o] || function ( ) { (w[o].q = w[o].q || [ ]).push(arguments) };
            js = d.createElement(s); fjs = d.getElementsByTagName(s)[0];
            js.id = o; js.src = f; js.async = true; fjs.parentNode.insertBefore(js, fjs);
      }(window, document, ‘script’, ‘eyeZon’,
  ‘<https://storage.googleapis.com/eyezonscriptv2/static/js/eyezonbutton script module
  475.js>’));
      eyeZon(‘init’, {
            businessId: ‘Your Business ID’
      });
      eyeZon(‘on’, ‘DIALOG_CREATED’, function(data) {
        if (data.predefinedMessageIndex === 0) {
  console.log(‘DIALOG_CREATED1’, data);
      } else if (data.predefinedMessageIndex === 1) {
          console.log(‘DIALOG_CREATED2’, data);
      }
  else
  {console.log(‘DIALOG_CREATED3’, data);
  }
  })
  </script>
```

Together with generating and sending the STREAM_CREATED event when the prospective purchaser entered a question or request in the text box portion 1030 of the video stream window 1010, the button script module 475 generates and sends a CLIENT_DATA_UPDATED event if the prospective purchaser adds her personal information for the client to use. Such data could include the prospective purchaser's name, email address, and phone number.

When the prospective purchaser joins the stream with a streamer the button script module 475 generates and sends STREAM_STARTED and STREAM_JOINED events to the statistics and analytics module 485. Upon the prospective purchaser ending the stream and closing the video stream window 1010, the button script module 475 generates and sends a STREAM_CLOSED event.

If the prospective purchaser comes back to the chat in the text box portion 1030 of the video stream window 1010, the button script module 475 generates and sends a CHAT_JOINED event. If the prospective purchaser comes back to the chat by pressing the video request button 140, the button script module 475 generates and sends both a CHAT_JOINED event and a BUTTON_CLICKED event.

If the prospective purchaser closes the video stream window 1010 by pressing the empty space around it or the close icon “x”, the button script module 475 generates and sends a CHAT_OVERLAY_CLOSED event to the statistics and analytics module 485.

If the prospective purchaser sends a voice message to the client or streamer outside of the conducted stream (after the stream has concluded or during the stream but by other means), the button script module 475 generates and sends an AUDIO_SENT event.

If the prospective purchaser clicks to watch a video sent by the streamer in the text box portion 1030 of the video stream window 1010 (not a recording of the stream but, for example, a video from prerecorded videos the streamer has saved on the streamer computer 160), the button script module 475 generates and sends a VIDEO_CLICKED event to the statistics and analytics module 485.

If the prospective purchaser clicks on the recording of the video broadcast she has had with the streamer, the button script module 475 generates and sends a STREAM_REPLAY_CLICKED event to the statistics and analytics module 485.

If the prospective purchaser clicks on a Product Page button (if the prospective purchaser is currently on a webpage with a different URL than that from which the video stream window 1010 was launched), the button script module 475 generates and sends a PRODUCT_PAGE_CLICKED to the statistics and analytics module 485. URLs are considered to be the same if they have the same address after the first level address. For example, if we have a webpage URL https://www.dewey.com/eyezon/52c73b0a37a04372b2b7f0401211dd, then another webpage which shares the exact bolded part (/eyezon/52c73b0a37a04372b2b7f0401211dd9d) is the same even if its first level domain address is different.

If after the stream has concluded and the prospective purchaser clicks on at least one star or other symbol as a rating of the streamer, the button script module 475 generates and sends a STREAM_RATED event to the statistics and analytics module 485. This event captures a streamID parameter and a Rating parameter.

If after the stream has concluded and the prospective purchaser is offered to rate the performance of the streamer but does not do that and instead clicks a close without rating button, the button script module 475 generates and sends a STREAM_MARKED_UNRATED event to the statistics and analytics module 485.

If the prospective purchaser while waiting for the streamer to appear clicks on a mini-game button, the button script module 475 generates and sends a GAME_OPENED event to the statistics and analytics module 485.

If the prospective purchaser clicked on a microphone button in the video stream window 1010 and thus enabled the video stream window 1010 to have access to the microphone on the prospective purchaser's computer 155 and/or successfully started an audio portion of the stream, the button script module 475 generates and sends a STREAM_MIC_ON event to the statistics and analytics module 485.

If the prospective purchaser fills out her email address for the streamer and the client, the button script module 475 generates and sends an EMAIL_NOTIFICATIONS_ON event to the statistics and analytics module 485. (This event is not generated for email notifications in response to a situation when there are no available streamers to presently conduct a stream.)

If the prospective purchaser agrees to receive PUSH notifications from the streamer and the client, the button script module 475 generates and sends a PUSH_NOTIFICATIONS_ON event to the statistics and analytics module 485. (This event is not generated for email notifications in response to a situation when there are no available streamers to presently conduct a stream.)

If PUSH notifications are sent (but not email or SMS communications), the button script module 475 generates and sends a FOLLOW_LINK event to the statistics and analytics module 485.

If the prospective purchaser agrees to receive SMS notifications from the streamer and the client, the button script module 475 generates and sends a SMS_NOTIFICATIONS_ON event to the statistics and analytics module 485. (This event is not generated for email notifications in response to a situation when there are no available streamers to presently conduct a stream.)

If the prospective purchaser clicks on the introductory video or unmutes the introductory video, the button script module 475 generates and sends an INTRO_VIDEO_CLICKED event to the statistics and analytics module 485.

If the streamer replied to the prospective purchaser's initial request and the prospective purchaser then responded to the streamer's first message (which is essentially the prospective purchaser's second message to the streamer), the button script module 475 generates and sends a CLIENT_FIRST_REPLIED event to the statistics and analytics module 485.

If the prospective purchaser agrees with the streamer's suggestion to add a product to a cart for purchase and the streamer adds it to the cart, the button script module 475 generates and sends a STREAMER_PUT_IN_CART_ACCEPTED event to the statistics and analytics module 485.

If the prospective purchaser declines the streamer's suggestion to add a product to a cart for purchase, the button script module 475 generates and sends a STREAMER_PUT_IN_CART_DECLINED event to the statistics and analytics module 485.

If either the prospective purchaser presses the add to cart button 1085 or the streamer adds a product to a cart for purchase, the button script module 475 generates and sends a PUT_IN_CART_FROM_BUTTON event to the statistics and analytics module 485.

When the product webpage notifies the button script module 475 that the product has been added to the cart for purchase and REST API call is made on the product webpage (which is the webpage on top of which the video stream window 1010 is created), the button script module 475 generates and sends a PUT_IN_CART event to the statistics and analytics module 485. (The client could vary when this event is generated and recorded by setting what the client considers adding to the cart.)

When the product webpage notifies the button script module 475 that the cart has been processed and an order for the product has been paid for and placed and REST API call is made on the product webpage (which is the webpage on top of which the video stream window 1010 is created), the button script module 475 generates and sends a CART_SUBMITTED event to the statistics and analytics module 485. (The client could vary when this event is generated and recorded by setting what the client considers placement and acceptance of an order.)

These two events may be implemented as follows:

eyeZon (‘emit’, ‘PUT_IN_CART’, [“target”]);

eyeZon (‘emit’, ‘CART_SUBMITTED’, [“target 1”, “target 2”], “orderId”);

where target, target 1 and target 2 are product identification, and orderId is the order number.

For each CART_SUBMITTED event generated and sent by the button script module 475, it also generates and sends a PRODUCT_SOLD_BY_STREAMER event (for each product sold by the streamer) to the statistics and analytics module 485.

For each CART_SUBMITTED event generated and sent by the button script module 475, it also generates and sends a PRODUCT_SOLD event (for each product possibly sold by or with the assistance of the streamer) to the statistics and analytics module 485.

In order to decide which of the two events to generate—a PRODUCT_SOLD event or a PRODUCT_SOLD_BY_STREAMER event—the button script module 475 searches in the computer memory for the corresponding value of the target parameter among active and recently closed streams: first among the active streams, then among closed streams, then the last active stream, then if no match was found previously the last closed stream value is taken. If a stream with the corresponding value of the target parameter is found, the button script module 475 considers that the product was sold as a result of the stream and sends the PRODUCT_SOLD_BY_STREAMER event. Otherwise, it sends the PRODUCT_SOLD event.

In the case of a PUT_IN_CART event, the button script module 475 works in the same way as with a CART_SUBMITTED event. When the PUT_IN_CART event is generated, the button script module 475 searches for target parameter match among active and recently closed streams. If target in the cart matches target in one of the streams, the button script module 475 considers that the product was added to the cart as a result of the prospective purchaser's interaction with the service.

For example, the prospective purchaser puts a blender (SKU-1) in the shopping cart. The button script module 475 generates the PUT_IN_CART event:

eyeZon (‘emit’, ‘PUT_IN_CART’, [“SKU-1”]);

Since the prospective purchaser has not yet started the stream, this event is ignored by the button script module 475. Then the prospective purchaser sends a request for another item, a TV set (SKU-2), and after talking with the streamer, adds it to cart. The button script module 475 generates the PUT_IN_CART event with a new ID:

eyeZon (‘emit’, ‘PUT_IN_CART’, [“SKU-2”]);

This event is logged by the button script module 475 because the item was added to the cart in the time range specified by hideEyeAfterMinutes cutoff period (which could have been set to 24 hours). If within 24 hours, the prospective purchaser has placed an order for the TV and the blender, the button script module 475 generates the CART_SUBMITTED event:

eyeZon (‘emit’, ‘CART_SUBMITTED’, [“SKU-1”, “SKU-2”], “ORDER_ID”);

Since the TV (SKU-2) was placed in the cart as a result of the stream with the streamer, the button script module 475 sends the PRODUCT_SOLD_BY_STREAMER event to the statistics and analytics module 485, which indicates that the product was sold by the streamer. The blender (SKU-1) was added to the cart before starting the stream with the streamer, so PRODUCT_SOLD is sent to the statistics and analytics module 485:

```
PRODUCT SOLD
{
  ...,
  dialogId: ‘*last-dialog-id*’,
  target: ‘SKU-1’
}
PRODUCT_SOLD_BY_STREAMER
{
  ...,
  dialogId: ‘*pertinent-dialog-id*’,
  target: ‘SKU-2’
}
```

If, within the cutoff period, the prospective purchaser also places an order for a product with a different target that the streamer recommended during the stream (for example, a TV set of another brand), the PRODUCT_SOLD event is sent to the statistics and analytics module 485. Subsequent CART_SUBMITTED events with the same orderId are ignored. If the prospective purchaser adds another item to the cart after a cutoff period, e.g., after more than 24 hours, this event is ignored because too much time has passed since the prospective purchaser's contact with the streamer to consider that this item was added to the cart as a result of the streamer's work.

If the prospective purchaser accepts an appointment to conduct a live video broadcast at a later date (for example, if no streamer is currently available, or if the streamer is not near the product to be discussed, etc.), the button script module 475 generates and sends an APPOINTMENT_CLIENT_ACCEPTED event to the statistics and analytics module 485.

If the prospective purchaser declines an appointment to conduct a live video broadcast at a later date (for example, if no streamer is currently available, or if the streamer is not near the product to be discussed, etc.), the button script module 475 generates and sends an APPOINTMENT_CLIENT_DECLINED event to the statistics and analytics module 485.

If the prospective purchaser cancels a previously scheduled appointment to conduct a live video broadcast at a later date (for example, if no streamer is currently available, or if the streamer is not near the product to be discussed, etc.), the button script module 475 generates and sends an APPOINTMENT_CLIENT_CANCEL event to the statistics and analytics module 485.

If the prospective purchaser keeps a previously scheduled appointment to conduct a live video broadcast at a later date (for example, if no streamer is currently available, or if the streamer is not near the product to be discussed, etc.) and shows up for the stream, the button script module 475 generates and sends an APPOINTMENT_CLIENT_SHOWED_UP event, after the prospective purchaser sends her initial request or question in the text box portion 1030 of the video stream window 1010, to the statistics and analytics module 485.

As a result of getting event notifications from the button script module 475, the statistics and analytics module 485 fills out a database table(s) which keep all the information regarding a stream. For example, such fields and their possible values could include:

| | |
|---|---|
| Dialog ID | A unique identifier for each stream generated by the |
| | system of one embodiment of the present invention |
| Dialog status | Active--when the stream is in progress, and |
| | Completed--once the stream is concluded |
| Streamer | Name of the streamer who is conducting the stream |
| Streamer ID | A unique identifier assigned to the streamer by the |
| | system of one embodiment of the present invention |
| Client ID | A unique identifier assigned to the client by the |
| | system of one embodiment of the present invention |
| Request sent | True or False logical values. |
| | True--if the prospective purchaser's request for a live |
| | video broadcast was sent into a queue for the video |
| | request button. |
| | False--if the prospective purchaser's request for a live |
| | video broadcast was not sent into a queue for the |
| | video request button. |
| Streamer2 | Name of the streamer who is conducting the stream, |
| | to whom streamer 1 has forwarded the stream |
| Streamer2 ID | A unique identifier assigned to the streamer2 by the |
| | system of one embodiment of the present invention |
| Client2 ID | A unique identifier assigned to the client by the |
| | system of one embodiment of the present invention |
| Button | Title of the video request button (e.g. product name) |
| Dialog | URL of the webpage on which the prospective |
| | purchaser clicked on the video request button |
| Webpage | URL of the webpage on which the prospective |
| | purchaser clicked on the video request button |
| City of the | The region value/parameter sent by the button script |
| prospective | module. |
| purchaser | For example, eyeZon(‘setAnalyticsParam’, ‘region’, |
| | ‘Berlin’); |
| SKU | By default, the URL of the webpage on which the |
| | prospective purchaser clicked on the video request |
| | button. Could be customized by the client. |
| Request date | Date the prospective purchaser requested the stream |
| Request time | Time of day the prospective purchaser requested the |
| | stream |
| Seconds to | Difference in seconds between the time the |
| Active Status | prospective purchaser requested the stream and when |
| | the streamer accepted the request and consequently |
| | the stream changed status to Active |
| Seconds to | Difference in seconds between the time the |
| Response to | prospective purchaser requested the stream and when |
| the Request | the purchaser sent her first substantive request or |
| | question to the streamer |
| Messages from | True or False logical values. |
| the Streamer | True--if the streamer has not sent any text messages |
| | or audio messages during this stream. |
| | False--if the streamer has sent a text message or an |
| | audio message during this stream |
| Video Broadcast | True or False logical values. |
| | True--The stremer has used a live video broadcast |
| | during the stream at least once. |
| | False--The stremer has not used a live video broadcast |
| | during the stream at least once. |
| Stream Date | Date the stream started |
| Stream Time | Time of day the stream started |
| Stream duration | Difference in seconds between the time the stream |
| | started and ended |
| Stream Recording | True or False logical values. |
| Watched | True--if the prospective purchaser watched the |
| | recording of the stream. |
| | False--if the prospective purchaser did not watch the |
| | recording of the stream. |
| Stream watched | True or False logical values. |
| live | True--if the prospective purchaser watched and |
| | participated in the stream live in real-time. |
| | False---if the prospective purchaser did not watch and |
| | participate in the stream live in real-time. |
| Web Push | True or False logical values. |
| Subscribed | True--if the prospective purchaser signed up for |
| | PUSH notification regarding the start of the stream |
| | False---if the prospective purchaser did not sign up |
| | for PUSH notification regarding the start of the |
| | stream. |
| Email | True or False logical values. |
| subscribed | True--if the prospective purchaser signed up for email |
| | notification regarding the start of the stream. |
| | False---if the prospective purchaser did not sign up |
| | for email notification regarding the start of the stream. |
| SMS Subscribed | True or False logical values. |
| | True--if the prospective purchaser signed up for SMS |
| | notification regarding the start of the stream |
| | False---if the prospective purchaser did not sign up |
| | for SMS notification regarding the start of the stream. |
| Client responded | True or False logical values. |
| | True--if the prospective purchaser participated in the |
| | stream (for example by audio or text messages, or |
| | speaking live into the microphone, or by drawing on |
| | the screen, etc.) |
| | False--if the prospective purchaser did not actively |
| | participate in the stream |
| Voice response | True or False logical values. |
| | True--if the prospective purchaser participated in the |
| | stream by voice or speaking live into the microphone |
| | at least once. |
| | False--if the prospective purchaser did not participate |
| | in the stream by voice or speaking live into the |
| | microphone. |
| Add to cart | True or False logical values. |
| notification | True--if the streamer presented add to cart notification |
| | to the prospective purchaser |
| | False---if the streamer did not present add to cart |
| | notification to the prospective purchaser. |
| Add to cart | True or False logical values. |
| activated | True--if the prospective purchaser clicked on the add |
| | to cart button. |
| | False--if the prospective purchaser did not click on |
| | the add to cart button. |
| Added to cart | Values or parameters sent through a PUT_IN_CART |
| | event |
| Purchased any | Values or parameters sent through a |
| product | PRODUCT_SOLD event |
| Purchased | Values or parameters sent through a |
| requested | PRODUCT_SOLD_BY_STREAMER event |
| product | |
| Stream link | A link to the stream in JSON format and links to the |
| | video and audio of the stream. |
| Client ID | Values or parameters added to extended script data. |
| (script data) | For example, eyeZon(‘setAnalyticsParam’, ‘clientId’, |
| | ‘123456’); |
| Purchaser's | Type of the prospective purchaser's computing |
| device | device--smartphone, laptop, desktop, tablet, etc. |
| Purchaser's phone | Purchaser's phone number if provided |
| number | |
| Purchaser's Email | Purchaser's Email if provided |
| Purchaser's name | Purchaser's name if provided |
| Stream rating | Rating assigned by the prospective purchaser to the |
| | streamer and the stream (for example, on a scale from |
| | 1 to 5) |
| Quick comments | Quick comments if provided regarding the stream |
| | selected by the prospective purchaser from pretyped |
| | options |
| Full comments | Full comments if provided by the prospective |
| | purchaser regarding the stream |

One way to enable the statistics and analytics module 485 to work is to associate the product with a stream via the target attribute and/or to configure the transfer of information regarding adding a product to the cart and order confirmation to the button script module 475 via the API method. The target attribute, which typically could be the product SKU number, the product webpage URL, or another identifier, helps to determine whether the live video broadcast was carried out for the product for which the order was placed. For example, the target attribute is configured using the data-eyezon-target parameter of the video request button 140:

<button data-eyezon
data-eyezon-target=”CEF537AWD”
data-eyezon-title= ”Haieronline, Haier refrigerator CEF537AWD,
29990”>
Start eyezon cbat
</button>

As a result of getting event notifications form the button script module 475, the statistics and analytics module 485 fills out a database table(s) which keep all the information regarding interactions of prospective purchasers with a video request button 140. For example, such fields and their possible values could include:

| | |
|---|---|
| Button Name | Name of a video request button |
| Date | Dates for the statistics and analytics report |
| Button Clicks | Number of all clicks on a video request button 140 (i.e., number of video |
| | broadcast requests) for a selected time period (day, week, month, etc.) |
| Sent requests | Number of video requests sent to the stream request processing module |
| | 480 for a selected time period (day, week, month, etc.) |
| Client left number | Number of video broadcast requests which did not result in a stream |
| | (e.g., the prospective purchaser clicked on a video request button 140 |
| | once and left) for a selected time period (day, week, month, etc.) |
| Number of video | Number of video stream requests for which the system found at least one |
| streams accepted | available streamer for a selected time period (day, week, month, etc.) |
| Streams with text | Number of streams where the streamer sent the prospective purchaser a |
| message | text message or an audio message for a selected time period (day, week, |
| | month, etc.). |
| Streams without text | Number of streams where the streamer did not send the prospective |
| messages | purchaser a text message or an audio message for a selected time period |
| | (day, week, month, etc.). |
| Deleted streams without | Number of deleted streams where the streamer did not send the |
| text messages | prospective purchaser a text message or an audio message for a selected |
| | time period (day, week, month, etc.). |
| Client active streams | Number of streams where the prospective purchaser send the streamer a |
| | text message or an audio message, or spoke with the streamer or used a |
| | virtual paintbrush for a selected time period (day, week, month, etc.). |
| Deleted streams without | Number of streams which the prospective purchaser deleted/abandoned |
| streamer's response | before the streamer responded for a selected time period (day, week, |
| | month, etc.) |
| Incomplete streams | Number of streams which the prospective purchaser deleted/abandoned |
| | after the streamer responded and during the stream for a selected time |
| | period (day, week, month, etc.) |
| Total streams | Number of streams for a particular video request button 140 for a |
| | selected time period (day, week, month, etc.) |
| Average stream | Average duration of all streams for a selected time period (day, week, |
| duration | month, etc.) |
| Average time to Active | Average duration of the prospective purchaser's wait time until the |
| status | streamer accepted the request and consequently the stream changed status |
| | to Active for a selected time period (day, week, month, etc.) |
| Average time to | Average duration of the prospective purchaser's wait time until the |
| Streamer's Response | streamer's first substantive response for a selected time period (day, |
| | week, month, etc.) |
| Number of working | Number of all requests for streams during working hours for a selected |
| hours streams | time period (day, week, month, etc.) |

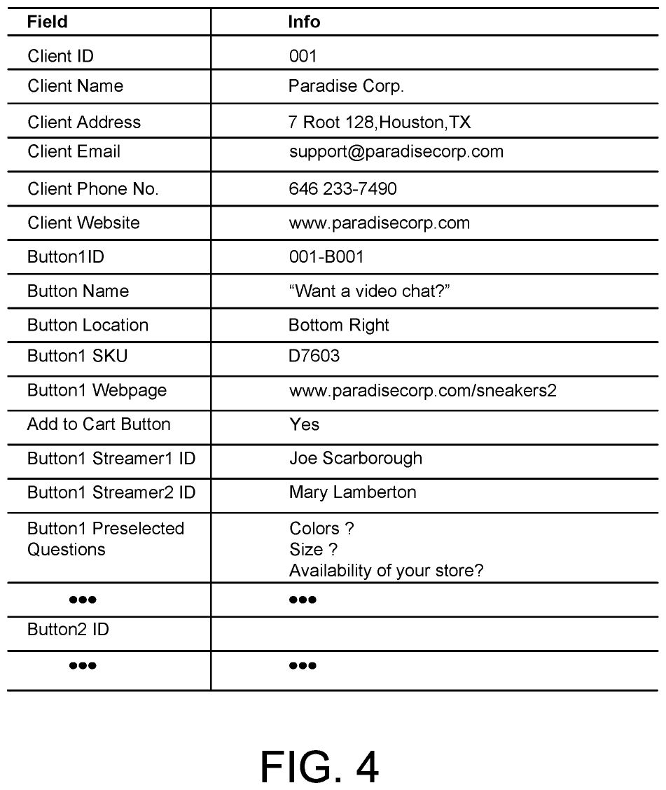

FIG. 4 depicts an exemplary excerpt of information stored by the system 100 for a client account whether or not client customization is available for a particular event and regardless of whether such customization was done. In this example, it is the client account for Paradise Corp. with client ID 001.

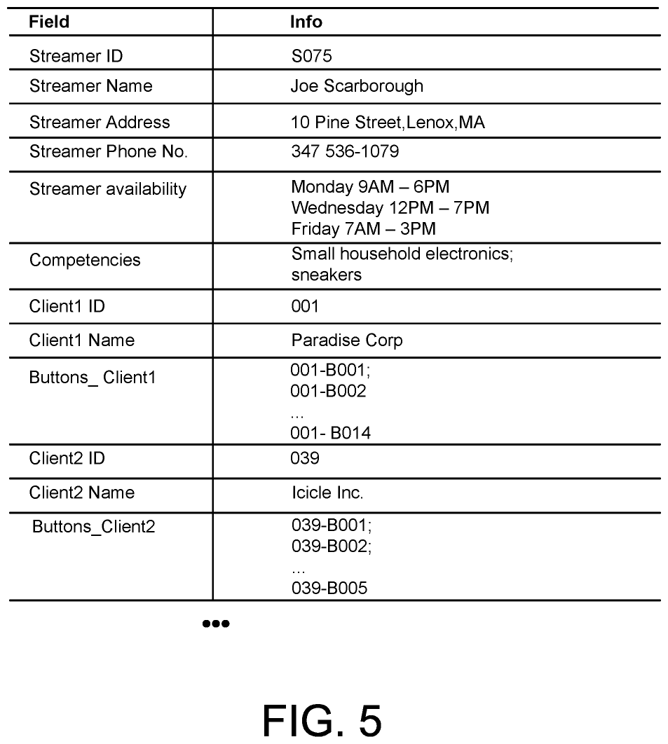

FIG. 5 depicts an exemplary excerpt of information stored by the system 100 for a streamer account. As we can see, Streamer Joe Scarborough is connected to 19 different video request buttons 140, including the video request buttons 140 for different unrelated clients Paradise Corp. and Icicle Inc.

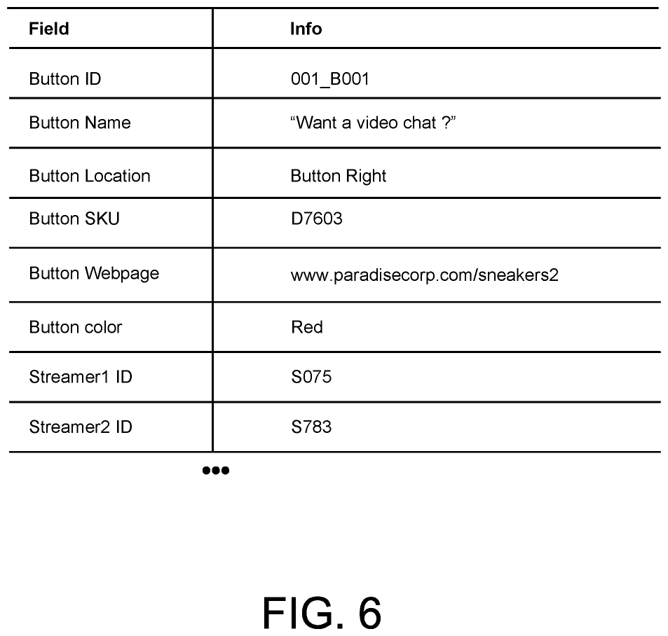

FIG. 6 depicts an exemplary excerpt of information stored by the system 100 for a video request button 140 for one of Paradise Corp's products with ButtonID 001_B001.

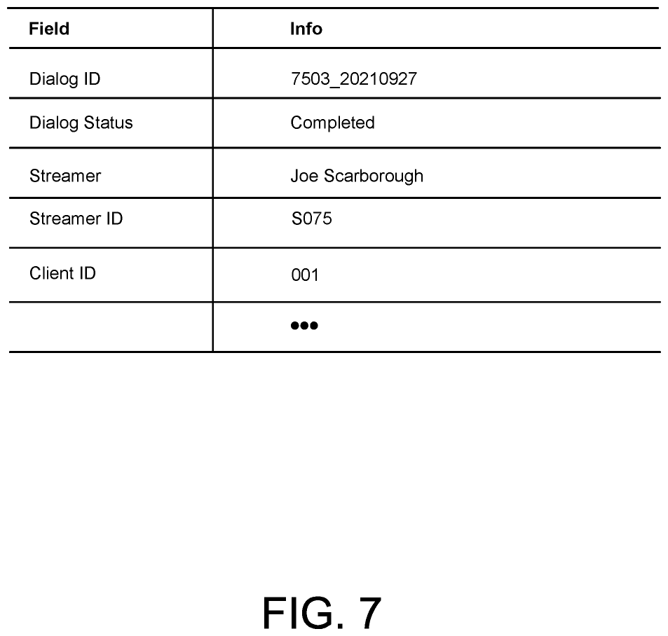

FIG. 7 depicts an exemplary excerpt of information stored by the system 100 for a stream in this case the stream completed by streamer Joe Scarborough with the DialogID 7503_20210927.

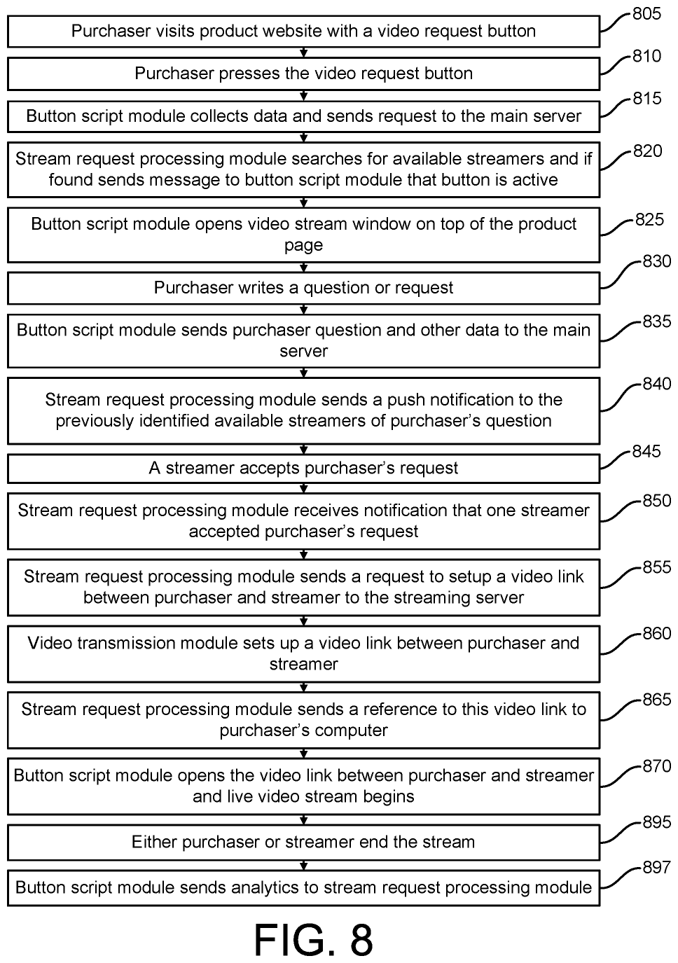

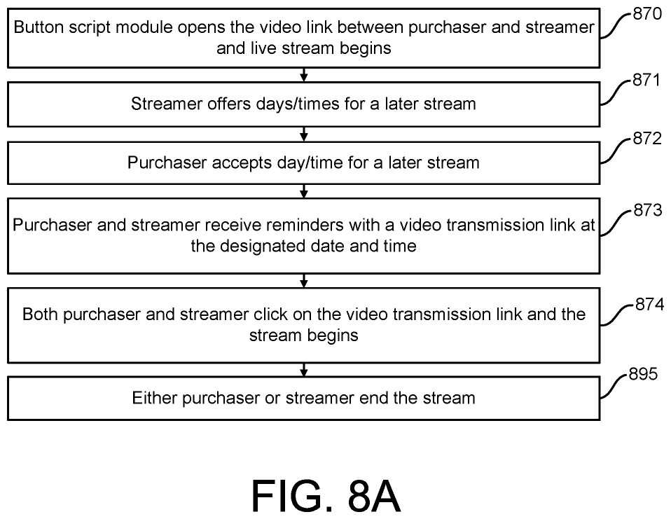

As illustrated in FIG. 8, in one embodiment of the present invention, a sequence of steps of one scenario of operation of the system 100 is depicted. At step 805 a prospective purchaser Amanda opens an Internet browser 105 on her computer 155 and visits the webpage for a coffee machine manufactured by DeLonghi on the website 120, of the client Dewey Corp., a retailer of household electronics, of system 100 (e.g., www.dewey.com/delonghicoffeemachine345.htm) This webpage for the De Longhi coffee machine, SKU 345, has the video request button 140 on it. At step 810, after reading the specification, customer reviews, seeing a promotional video about the De Longhi coffee machine, SKU 345, Amanda still has some unanswered questions about this coffee machine (e.g., whether it can handle overroasted coffee beans and still make good coffee? And whether its espresso and cappuccino preparation functions are fully automatic? And whether it can also make hot chocolate or hot cider?). So Amanda sees the video request button 140 on this product page and presses it to get answers to her questions via a live video broadcast with a knowledgeable sales person.

At step 815, the button script module 475, which is connected to the video request button 140 and stored on the client's website, is activated because Amanda pressed the video request button 140. The button script module 475 then sends an event BUTTON_CLICKED to the statistics and analytics module 485. The button script module 475 also collects the data regarding the purchaser Amanda such as the cookies information, browser type, time of day, and optionally prospective purchaser's name, email address, and phone number, and information regarding the product and website for which Amanda clicked the video request button 140 such as what is the product Amanda is interested in—the De Longhi coffee machine, SKU 345, how much time has she spent on that product's webpage, how much time has she spent on the client's website, has she visited this product page or client's website before, etc. After collecting all available data, the button script module 475 sends a video stream request via REST application programming interface (API) to the main server 115.

At step 820, the stream request processing module 480 running on the main server 115 receives the video stream request from the button stream request 475, and conducts a search in the streamer database residing on the main database server 130 for streamers connected with the video request button for the De Longhi coffee machine, SKU 345, and checks their availability status to conduct a live video broadcast with Amanda now. In this example, the stream request processing module 480 found 3 streamers Stephan, Stork, and Stella who are both connected with the video request button for the De Longhi coffee machine, SKU 345, and are available now. Because it found at least one available streamer, the stream request processing module 480 accesses the technical parameters information for the video stream window set by the client Dewey and stored in Dewey's account (e.g., that the language is set to English, the border of the window should be red, and that the three pre-typed messages to be shown to the purchaser are “I need more technical details”, “What are the customization options?”, and “How long do I have to wait for an upgrade?”). And the stream request processing module 480 returns a message to the button script module 475 running on the product page for the coffee machine that the button is active and the technical parameters for the video stream window from Dewey's account.

At step 825, the button script module 475 receives the message that the button is active and opens up the video stream window 1010 using the technical parameters transmitted to it. The button script module 475 creates two portions in the video stream window 1010, an upper portion, the video portion 1020, which now shows a high resolution picture of the De Longhi coffee machine, SKU 345, and a lower portion, the text box portion 1030, for text messaging. In the text box portion 1030, the button script module 475 places the text “How could we help you?” and three possible answers “I need more technical details”, “What are the customization options?”, and “How long do I have to wait for an upgrade?” for Amanda to choose from, and space for Amanda to type her own question. The video stream window 1010 is opened on top of the product page for the De Longhi coffee machine, SKU 345, (www.dewey.com/delonghicoffeemachine345.htm) without moving away from this page or accessing any third party video communication services such as Skype or WhatsApp.

At step 830, Amanda writes her question or request in the text box portion 1030. In this example, Amanda did not choose pre-typed common requests, and typed “Can it also make hot chocolate or hot cider?” and pressed a send button 1080. At step 835, the button script module 475 sends Amanda's question and other data via REST application programming interface (API) to the main server 115. The button script module 475 also sends an event STREAM_CREATED to the statistics and analytics module 485.

At step 840, the stream request processing module 480 running on the main server 115 receives Amanda's question and other data from the button stream request 475, and sends a notification to the three available streamers Stephan, Stork, and Stella who are connected with the video request button for the De Longhi coffee machine, SKU 345, that Amanda is seeking a stream to answer her question “Can it also make hot chocolate or hot cider?” These streamers receive a PUSH notification.

At step 845, each of the streamers Stephan, Stork, and Stella click on the PUSH notification they received on their computers in the streamer application 165 and see Amanda's question “Can it also make hot chocolate or hot cider?” Streamer Stella clicks on Amanda's question which means that she accepted Amanda's request for a live video broadcast. The streamer application 165 sends notification that streamer Stella accepted Amanda's request to the stream request processing module 480 running on the main server 115 via REST application programming interface (API).

At step 850, the stream request processing module 480 running on the main server 115 receives notification that streamer Stella accepted Amanda's request and sends notification to the streamer applications 165 running on computers of other available streamers Stephan and Stork to delete Amanda's request from their streamer applications 165 because streamer Stella accepted it first. In other embodiments of the present invention other ways of assigning a streamer out of many available streamers may be implemented: closest geographically to the prospective purchaser, most experienced in years of service, etc., most successful in closing a sale during a stream, auction, bidding, etc.

At step 855, the stream request processing module 480 running on the main server 115 sends a request, via REST application programming interface (API), to the streaming server 125 to set up a video transmission link between the video window 1010 on Amanda's computer and streamer application 165 on streamer Stella's computer.

At step 860, the video transmission module 170 running on the streaming server 125 receives this request and sets up the video link between the video window 1010 on Amanda's computer and streamer application 165 on streamer Stella's computer, and creates a reference to this video link and sends it to the stream request processing module 480 running on the main server 115.

At step 865, the stream request processing module 480 running on the main server 115 receives the reference to the video link between Amanda and Stella and sends this reference to the button script module 475 on Amanda's computer. At step 870, the button script module 475 on Amanda's computer opens the video link by passing this reference to the video window 1010 on Amanda's computer and live video stream between prospective purchaser Amanda and streamer Stella begins. The button script module 475 also sends events STREAM_STARTED and STREAM_JOINED to the statistics and analytics module 485. In response to Amanda's question “Can it also make hot chocolate or hot cider?” Stella replies in the text box “Sure. It can make both. Do you want me to show you how?” Amanda then replies “Yes, I would love to learn how.” At this point in the stream, the button script module 475 sends event CLIENT_FIRST_REPLIED to the statistics and analytics module 485.

In addition to live audio and video Amanda and Stella used text messages with and without attachments (which were text, audio, and video files) and virtual paintbrush module. As a result of Stella's efforts during the stream, Amanda decided to purchase the De Longhi coffee machine, SKU 345, and clicked on the add to cart button 1085 in the video window 1010 (at which point the button script module 475 sends an event PUT_IN_CART_FROM_BUTTON to the statistics and analytics module 485) and after the stream ended completed this purchase on Dewey's website. Alternatively, streamer Stella could have clicked on the add to cart button 1085 in the video window 1010 to add the De Longhi coffee machine, SKU 345 to Amanda's cart. For example, the PUT_IN_CART_FROM_BUTTON and STREAMER_PUT_IN_CART_ACCEPTED events may be implemented as follows:

```
  <script>
  (function (w,d,s,o,f,js,fjs) {
  w[o] = w[o] || function ( ) { (w[o].q = w[o].q ||[ ]).push(arguments) };
  js = d.createElement(s); fjs = d.getElementsByTagName(s)[0];
  js.id = o; js.src = f; js.async = true;fjs.parentNode.insertBefore(js,
fjs);
  } (window, document, ’script’, ’eyeZon’,
’https://storage.googleapis.com/eyezonscriptv2/static/js/eyezonbutton script
module 475.js’)); eyeZon (’init’, {
  businessId; ’your-business-id’,
  region: ’ru-1’
  });
  eyeZon(’ on’, ’PUT_IN_CART_FROM_BUTTON’, function(data) {FUNCTION});
  eyeZon(’ on’, ’STREAMER_PUT_IN_CART_ACCEPTED’, function(data) {FUNCTION});
</script>
```

where parameter FUNCTION should be replaced with functions/action which trigger the addition of a product to the cart and with an action of sending this event to the statistics and analytics module 485.

At step 895, Amanda ended the stream by closing the video window 1010. As a result, the button script module 475 sends an event CHAT_OVERLAY_CLOSED to the statistics and analytics module 485.

At step 897, the button script module 475 sends, via REST application programming interface (API), a message to the stream request processing module 480 running on the main server 115 with analytics regarding the stream between Amanda and Stella. The stream request processing module 480 processes this message and analytics and stores them in the main database 130.

The recording of this video stream between Amanda and streamer Stella, which lasted for 10 minutes 27 seconds, is made by the video transmission module 170 and is kept in the streaming database 135. This recording is available to both Amanda for later viewing, streamer Stella and her employer Dewey for analysis and quality control and improvement.

As illustrated in FIG. 8a, after alternatively returning to step 870 in FIG. 8, at step 871, the streamer Stella offers the prospective purchaser Amanda available dates and times to schedule a live video stream for later: “Are you available on Wednesday at 10:30 or 11:30 am so I could show you a new upgraded model which I am getting tomorrow?” At step 872, Amanda accepts the 11:30 am time on Wednesday for a stream. When the date and time for the stream come, for example, Wednesday in this case, at step 873 the stream request processing module 480 at about 11:20 am sends a notification to both Amanda and Stella with a link for a video transmission link for this stream. This notification could be sent by email, text message, etc. At step 874, both Amanda and Stella click on the video transmission link and the stream begins. At step 895, Amanda ended the stream by closing the video window 1010.

Below is a sample fragment of the textual portion of another exemplary live video broadcast presented in JSON or JavaScript Object Notation. JSON is a language-independent open data format that uses human-readable text to express data objects consisting of attribute-value pairs. While originally derived from the JavaScript scripting language, JSON data can be generated and parsed with a wide variety of programming languages including JavaScript, PHP, Python, Ruby, and Java.

| | |
|---|---|
| JSON 1.1 | JSON 1.2. |
| {“_id”:{“$oid”:“”},“updatedAt”:{“$date”:“”}, | { |
| “createdAt”:{“$date”:“”},“user”:{“$oid”:“”},“ | “_id”: “”, |
| business”:{“$oid”:“”},“askedUserData”:“NA | “updatedAt”: “”, |
| ME”,“greetingText”:“Feel free, to ask! | “createdAt”: “”, |
| \nOur consultants would be glad to | “button”: “”, |
| answer all your | “worker”: “”, |
| questions”,“waitingText”:“While | “status”: “ACTIVE”, |
| somebody from our team is getting | “client”: “”, |
| ready to help you, you could close this | “title”: “Dialog title”, |
| window and keep browsing our website. | “description”: “Dialog description”, |
| You will get a notification that the | “websiteUrl”: “http://localhost:8080/”, |
| stream is about to | “isClientOnline”: false, |
| begin.”,“mainText”:“STRINQ”,“name”:“KT | “rating”: O, |
| - | “target”: “Duis irure”, |
| mecm1”,“dialogs”:[ ],“workers”:[{“$oid”:“”} | “acceptTime”: “”, |
| “domains”:[ ],“_v”:q,“languages”:[{“$oid”:“ | “answerTime”: “”, |
| ”}],“languageSpecificFields”:[{“_id”:{“$oid”: | “isButtonAvailable”: true, |
| “”},“value”:“Name”,“field”:“name”,“languag | “quickComments”: [ |
| e”:{“$oid”:“”},“localization”:“en”},{“value”:[“ | “Quick comment”, |
| Want to see it live”,“I have question | “Quick comment” |
| about this product”,“I want to compare | ], |
| it with a different | “comment”: “Comment”, |
| model”],“field”:“questionExamples”,“langu | “canPutlnCart”: true, |
| age”:{“$oid”:“”},“_id”:{“$oid”:“”},“localizatio | “putlnCart”: “ACCEPTED”, |
| n”:“ru”}],“questionExamples”:false,“chatC | “streamingBackend”: “”, |
| olor”:“#FF2D55”,“countdown”:60000,“g | “recordsUrl”: “http://localhost:8080/”, |
| reetingTitle”:“Feel free to | “requestReturned”: false, |
| ask!”,“miniGame”:true,“position”:“BOTTO | “requestReturnedText”: “” |
| M_RIGHT”,“requestFieldText”:“Please | } |
| enter your | |
| question!”,“waitingTitle”:“Thank you for | |
| your | |
| inquiry!”,“metric”:{“$oid”:“”},“sendUserDa | |
| taToChat”:true,“statisticEvents”:[ ],“localiz | |
| ations”:[ ],“phoneMask”:[ ],“isPhoneMaskA | |
| vailable”:false,“alwaysRequestClientInfo”:n | |
| ull,“isSmsAvailable”:null,“isDeleted”:false,“ | |
| defaultPhoneCountry”:null} | |

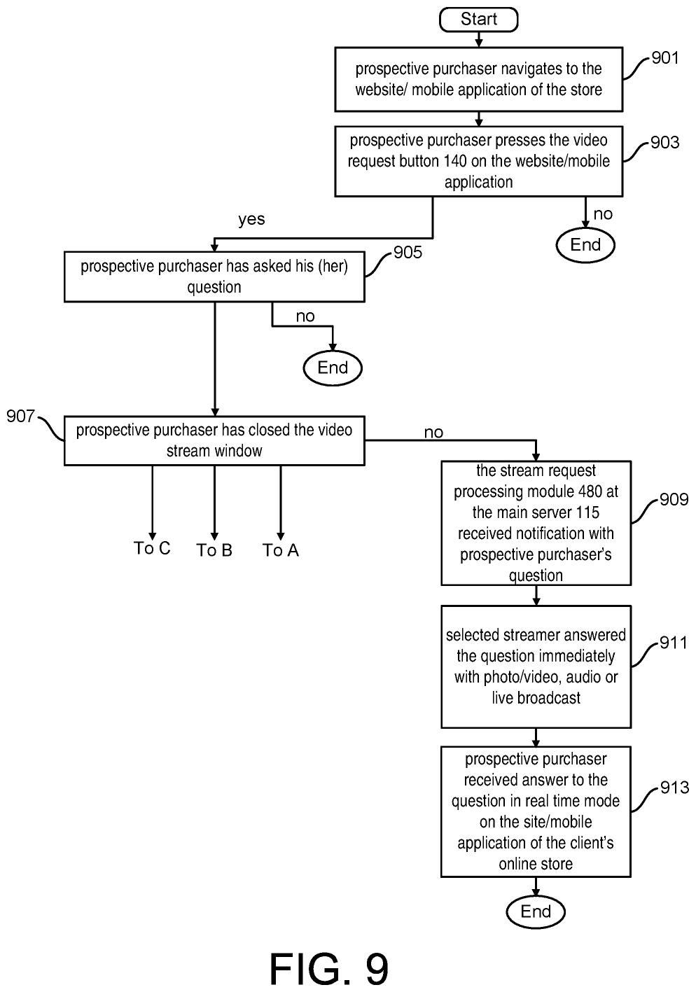

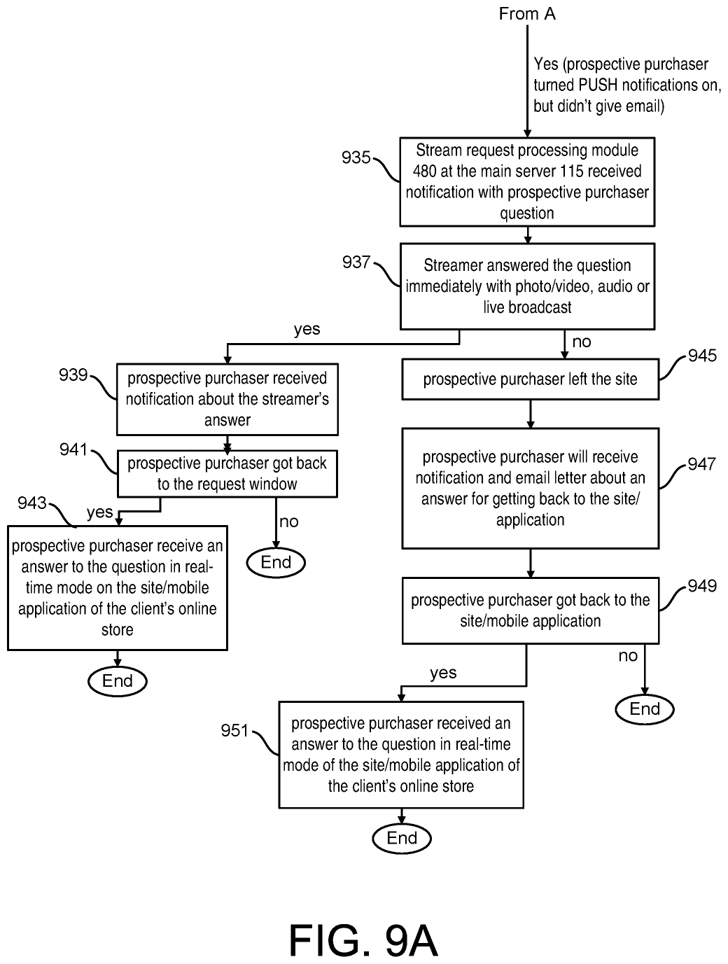

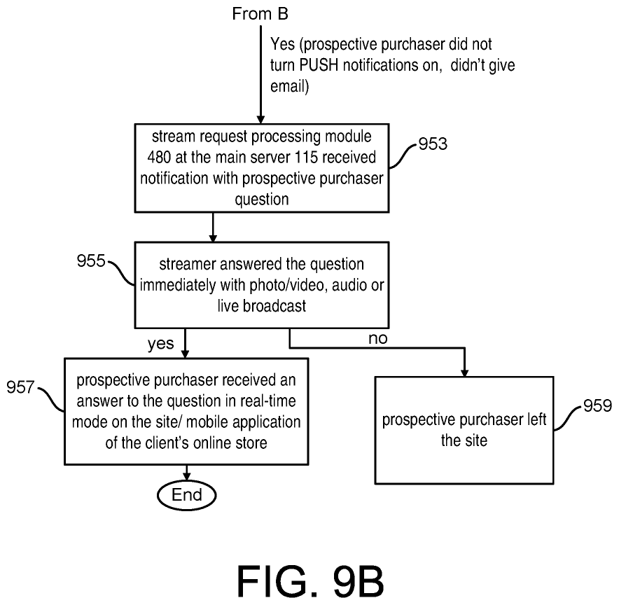

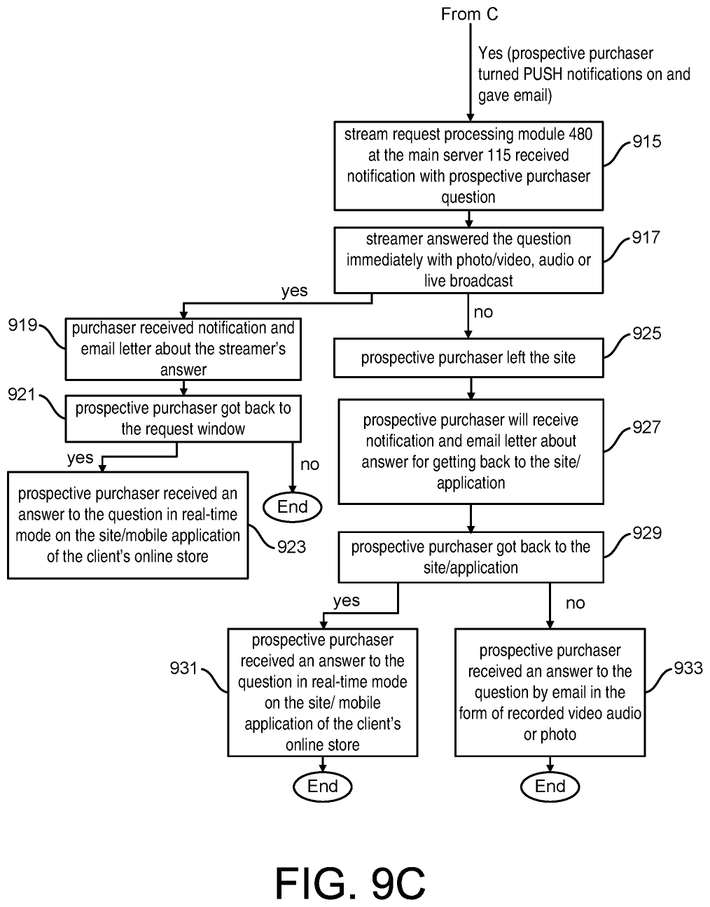

As illustrated in FIG. 9, in one embodiment of the present invention, additional scenarios of the work of the system 100 are illustrated. At step 901, on the prospective purchaser device, prospective purchaser or user navigates to the web site or mobile application of the store. At step 903, prospective purchaser presses the video request button 140 on the website/mobile application of the client's online store. At step 905, the prospective purchaser has asked his (her) question. At step 907, the prospective purchaser has closed the video stream window 1010. If the prospective purchaser has not closed the video stream window 1010, then at step 909, the stream request processing module 480 at the main server 115 received notification with prospective purchaser's question. At step 911, the selected streamer answered the question immediately with photo/video, audio or live broadcast. At step 913, the prospective purchaser received answer to the question in real-time mode on the site/mobile application of the client's online store.

If the prospective purchaser has closed the video stream window at step 907 and the prospective purchaser turned PUSH notification on and gave email address, then, at step 915 in FIG. 9C, the stream request processing module 480 at the main server 115 received notification with the prospective purchaser question. If at least one streamer is available and accepted the request, at step 917 the streamer answered the question immediately with photo/video, audio or live broadcast. Then at step 919, the prospective purchaser received notification and email letter about the streamer's answer. If the prospective purchaser got back to the request window in step 921, then at step 923 the prospective purchaser received an answer to the question in real-time mode on the site/mobile application of the client's online store.

Going back to step 915, if at least one streamer is not available and did not answer the question immediately with photo/video, audio or live broadcast in step 917, then at step 925, the prospective purchaser left the site. At step 927, when the streamer has replied, the prospective purchaser will receive notification and email letter about answer for getting back to the site/application. If the prospective purchaser got back to the site/application in step 929, then in step 931, the prospective purchaser received an answer to the question in real-time mode on the site/mobile application of the client's online store. If the prospective purchaser did not get back to the site/application in step 929, then in step 933, the prospective purchaser received an answer to the question by email in the form of recorded video, audio or photo.

If the prospective purchaser has closed the video stream window at step 907 and prospective purchaser turned PUSH notification on but did not give email address, then, at step 935 in FIG. 9A, the stream request processing module 480 at the main server 115 received notification with the prospective purchaser question. If at least one streamer is available and accepted the request, at step 937 the streamer answered the question immediately with photo/video, audio or live broadcast. Then at step 939, the prospective purchaser received notification about the streamer's answer. If the prospective purchaser got back to the request window in step 941, then at step 943 the prospective purchaser received an answer to the question in real-time mode on the site/mobile application of the client's online store.

Going back to step 937, if at least one streamer is not available and did not answer the question immediately with photo/video, audio or live broadcast in step 937, then at step 945, the prospective purchaser left the site. At step 947, when the streamer has replied, the prospective purchaser will receive notification and email letter about an answer for getting back to the site/application. If the prospective purchaser got back to the site/mobile application in step 949, then in step 951, the prospective purchaser received an answer to the question in real-time mode on the site/mobile application of the client's online store.

If the prospective purchaser has closed the video stream window at step 907 and the prospective purchaser did not turn PUSH notification on and did not give email address, then, at step 953 in FIG. 9B, the stream request processing module 480 at the main server 115 received notification with the prospective purchaser question. If at least one streamer is available, at step 955 the streamer answered the question immediately with photo/video, audio or live broadcast. Then at step 957, the prospective purchaser received an answer to the question in real-time mode on the site/mobile application of the client's online store. Otherwise, at step 959 the prospective purchaser left the site.

At the end of the stream where the prospective purchaser purchased the client's product, the streamer asks the prospective purchaser whether he wants to become a streamer for this product. If the answer is “Yes,” the client has an opportunity to enroll this purchaser as a streamer. Other ways and criteria for enrolling prior purchasers and others as streamers may be used.

The system 100 also offers an opportunity for a consumer to consumer commerce. For example, in addition to the client's sales representatives being available to conduct online live video broadcasts regarding particular products and services, prior purchasers of those goods and services may also become streamers and conduct live video streams with prospective customers. Upon purchasing a particular product by the purchaser, the button script module 475 receives information from the stream request processing module 480 that this purchaser bought this product and opens up a video stream window 1010 and in the text box portion 1030 causes a message to be displayed to the purchaser: “Would you like to become a streamer to answer prospective buyers' questions about the product you just bought?” If the purchaser agrees to become a streamer, the system 100 creates a streamer account for the purchaser and requests necessary information from the purchaser regarding her name, address, availability, etc. Such prior purchaser streamers are connected in the same way to particular video request buttons 140 and could accept or decline video stream requests. When such prior purchasers become streamers, they could conduct live video broadcasts following the sequence of steps in FIG. 8.

The system 100 also offers an opportunity for cooperative, group shopping experience. In some embodiments of the present invention, the prospective purchaser may invite his friends and colleagues who may be interested in the same product or service, or who could advise the prospective purchaser regarding whether or not to buy this product to view and participate in the live stream together with the prospective purchaser. In such a case, the purchaser selects an option for co-viewing in the video request button 140 and enters names and email addresses for her friends she wants to invite. The button script module 475, in addition to initiating the stream according to the steps in FIG. 8, sends shareable links to the stream to the invited guests. The invited guests can join the stream by opening the shareable links they received. The invited guests do not have the privilege of inviting others but they have an ability to fully participate in the stream such as by speaking and texting the streamer and watching the streamer. Such communications are visible to all participants in the stream. Only the prospective purchaser as a host of the stream has an ability to add the product to the cart.

In addition to offering live video broadcast with knowledgeable sales people to prospective purchasers online, the system could be activated by an offline prospective purchaser too. For example, a prospective purchaser who is not browsing the Internet but is reading a magazine could encounter a product or service advertisement in the magazine with a QR code printed on it. For example, Ms. Marple is reading a gardening magazine and sees an advertisement for a new garden irrigation system with a QR code. Ms. Marple could take out her smartphone, open a camera application on it, and scan the QR code in the advertisement with the camera application. Then the smartphone will convert the QR code into a URL for a webpage where a window would open for a live video consultation with a streamer regarding the advertised garden irrigation system. This webpage could be a webpage of the garden irrigation system (or another webpage) on the website of the advertiser who placed that advertisement in the gardening magazine, or it could be a special webpage not part of the advertiser's website, etc.

In another embodiment of the present invention, in addition to providing live video streaming to offline purchasers, a prospective purchaser could request a live video streaming by clicking on a video request button in a targeted email sent to this prospective purchaser, on an online advertising banner, or in a video, for example a video advertisement or a video hosted on Youtube.com or a similar service. In some embodiments of the present invention, any click on an online advertising banner, or in a video could be considered as a request for a live video broadcasting (without having a special video request button to click). After the click, the system could open a video broadcasting window on the advertising banner or video where the click was made and initiate the video streaming according to an embodiment of this invention. Alternatively, the system could open the advertiser's product webpage or a special webpage, and open a video broadcasting window there.

In some embodiments of the present invention, the system provides the prospective purchaser a virtual paintbrush tool to use during the live video streaming with the sales representative. This tool allows the purchaser to draw a line on the objects in the video stream window with the aid of the cursor, by marking a fragment of the picture or drawing a symbol to better point out what the purchaser is interested in. The line drawn by the virtual paintbrush tool is then drawn by the system in the same place on the streamer's video screen. The line drawn by the virtual paintbrush tool disappears from the screens after some time. Referring to FIG. 10, during a live video stream, the prospective purchaser is watching this stream in the video stream window 1010 on her computer 155. In a video portion 1020, the streamer is displaying a chair and the purchaser wants to attract the streamer's attention to the backrest portion of the chair. In order to do that, the purchaser clicks on a virtual paintbrush button 1040 which activates a virtual paintbrush mode on the purchaser's side of the stream. (Activating the virtual paintbrush mode disables the text messaging function of the video stream window 1010 in some embodiments.) In the virtual paintbrush mode, a subsequent mouse click by the purchaser and movement of the cursor on her screen over the chair backrest forms an array of cursor coordinates in the video portion 1020 of the video stream window 1010 (from the earliest to the latest) and draws a line or another geometric shape or object. When the purchaser releases the mouse button, which means that the purchaser finished using the virtual paintbrush and completed drawing her object (in this example a squiggly line 1050 over the chair backrest), the system draws the squiggly line 1050 over the chair backrest in the video portion 1020 of the video stream window 1010 on the purchaser's side. The system then transmits the completed array of cursor coordinates via websockets over the network 110 to the main server 115 which in turn transmits it over the network 110 to the streamer's computing device 160 which has the streamer application 165 running. The system via the streamer application 165 draws a corresponding line or an object with the received coordinates on the screen of the streamer's computing device 160. As a result a squiggly line 1060 over the chair backrest appears on the screen in the streamer video window 1070. The squiggly line 1060 is an exact copy of the squiggly line 1050. After a few seconds, the squiggly lines 1050 and 1060 are deleted from the respective computer screens, in some embodiments from the earliest cursor coordinates to the latest.

The virtual paintbrush mode could alternatively be activated by the prospective purchaser moving a slider switch on the video stream window 1010 to an appropriate mode: when the virtual paintbrush mode (slider to the right) is activated, the purchaser is unable to send text messages; when the text message mode is activated (slider to the left), the user is unable to use the virtual paintbrush tool.

It is noticeable that different embodiments of the present invention contain features and advantages lacking in the prior art systems. For example, https://www.goinstore.com and https://www.brand.live lack, among others, the virtual paintbrush mode, the ability to have multiple guests join the host in the stream with the streamer, the ability to have a previous purchaser of the product be a streamer, recording and replay of the stream, recording and replay of a video presentation by the streamer if the prospective purchaser did not show up or complete the stream, the ability to initiate a stream from scanning a QR code, and many other features.

In another embodiment of the present invention, the system comprises the following elements

Client (C1, e.g., desktop/laptop, C2, e.g., mobile phone);

Manager/Seller (SM1, e.g., mobile phone);

Main server (S1);

Streaming server (S2);

Main server database (D1);

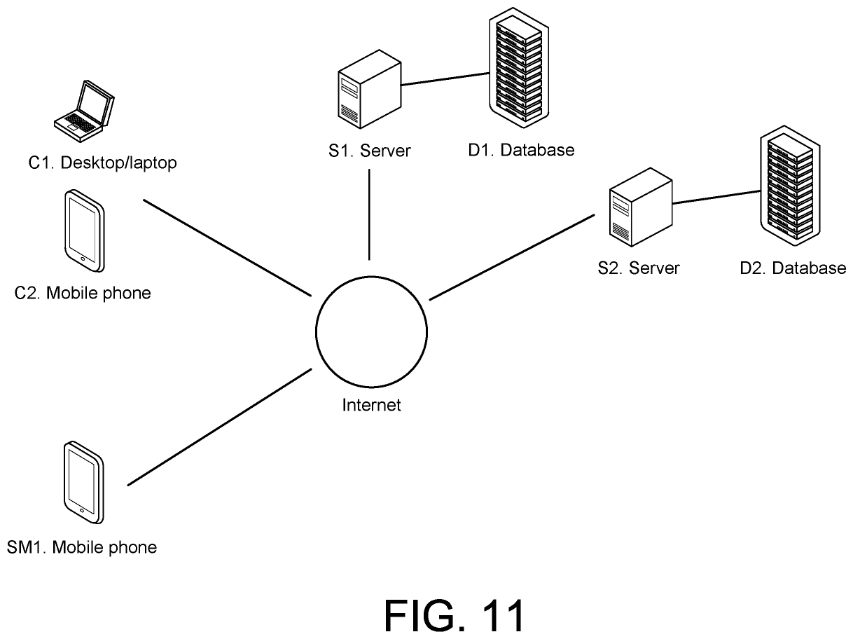

Streaming server database (D2); all of the above connected to the Internet and comminicatively coupled as shown in FIG. 11;

wherein at the boot or setup stage:

the Client (C1, C2) enters the website/mobile application of the store; when going to the product page, the Client (C1, C2) sees the K1 button; when the K1 button is pressed, the Client's device (C1, C2) sends a request to the server (S1), which server processes the request and performs search for sellers (SM1) connected to the button K1 through the database (D1) on/in the website/mobile application of the store; the server (S1) returns a response to the Client's device (C1, C2), and interface with a field for entering a request is loaded on the client's device,

wherein at the step of sending the request:

the Client (C1, C2) enters his (her) request in the field for entering a request and clicks the K2 button to send it; when pressing the “send” button K2, the Client's device (C1, C2) sends a request to the server (S1); the server (S1) processes the request and forwards it to the seller(s) (SM1); the seller(s) (SM1) in turn receives a PUSH notification to the device on which the mobile application is installed,

wherein at the step of responding to the request:

the Seller(s) (SM1), when clicking on the notification, switches to the mobile application, where he (she) sees a list of requests; when clicking on the request, the seller (SM1) can either respond to it or reject it; if the seller (SM1) responds to the request, then the seller's device (SM1) sends a request to the server (S1), the server (S1) processes the request, creates a room between the seller (SM1) and the client (C1, C2), and at this moment it sends a response to the devices of other sellers, and the given request is deleted from them; the Seller (SM1) can respond to the client's request (C1, C2) with photo, audio, video and/or live broadcast; when clicking on the Live broadcast button K3, the seller's device (SM1) sends a request to the server (S1) and opens the camera, the server (S1) processes the request and sends a request to the Server (S2), which server generates a link to the live broadcast, then the Server (S2) responds to the request of the Server (S1) and transmits the link to the live broadcast,

wherein at the step of receiving a response:

the Server (S1) transmits the received link to the client's device (C1, C2); the client (C1, C2) in turn receives a notification about the start of the live broadcasting and sees the K4 button; when it is pressed, a window is opened on the client's device where the client (C1, C2) watches the live broadcasting from the seller (SM1), wherein the client (C1, C2) can use an input field in this window to communicate with the seller (SM1) during the live broadcasting.

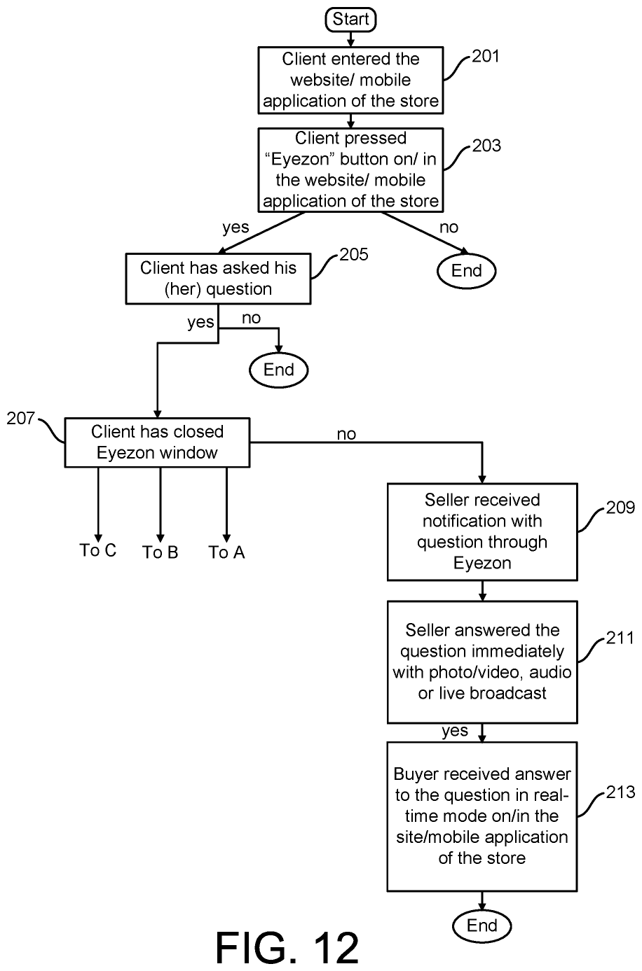

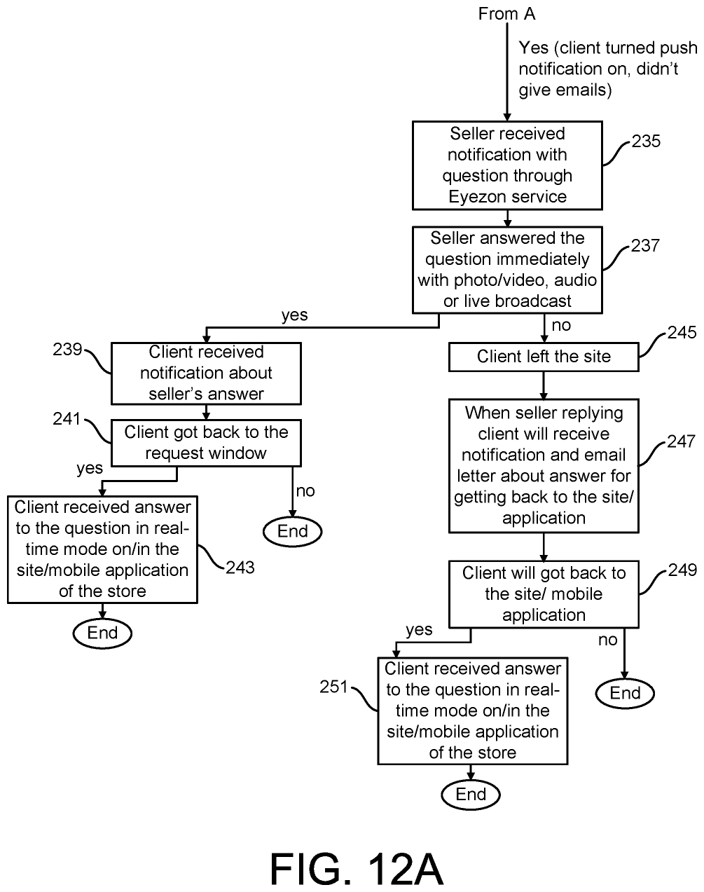

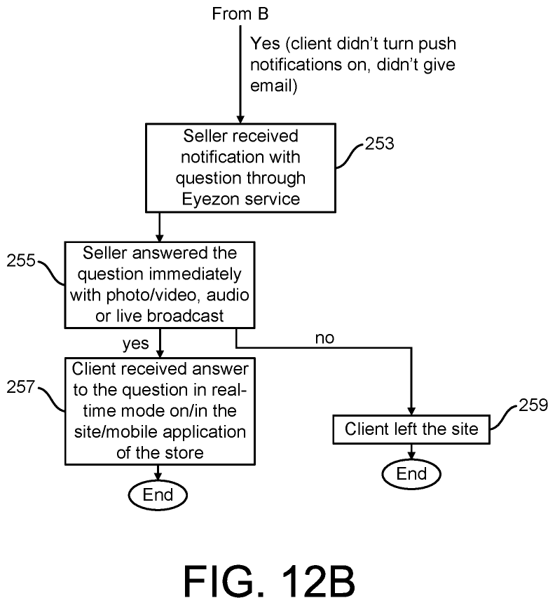

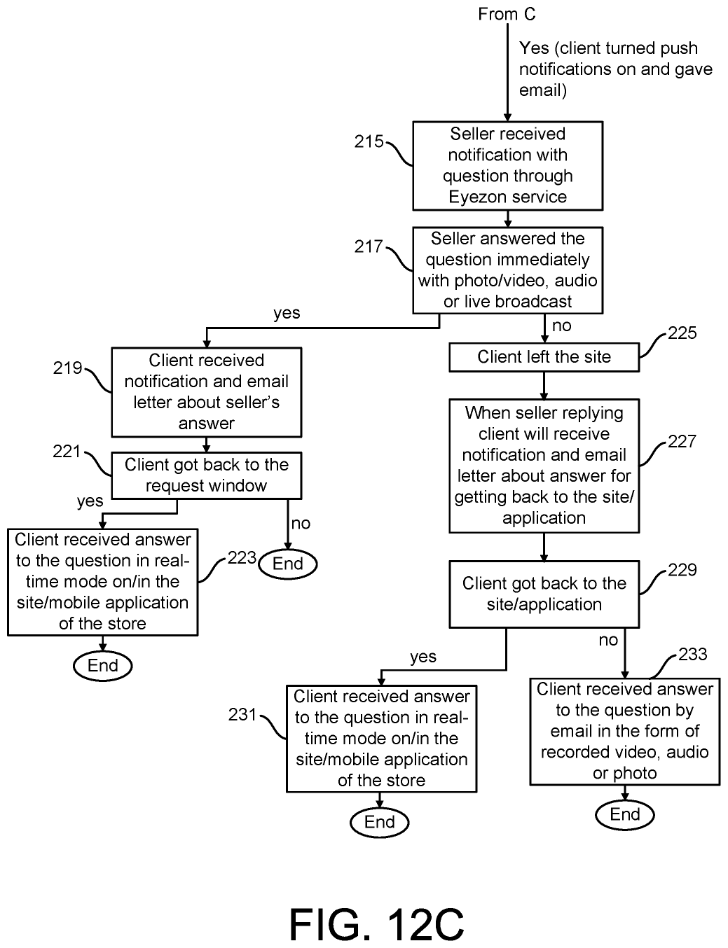

The claimed group of inventions provides the switching from a visual or text description of an object or place provided on the page of any online platform (site) to individual video broadcast thereof in real-time mode at user request (see the example in FIG. 12). A live video broadcasting of an object or place is carried out on the same page of the site where the visual or text description thereof is provided, without going over and using other services or tools for exchanging video, audio or text messages, and also without using video call tools or services.

To switch from the visual or text description of the object presented on the site page, the user clicks on a button, icon or image to which the Eyezon script is connected. After clicking, a pop-up window appears on the same object description page, in which window a clarifying question or wishes for a live video broadcast about an object or place of interest can be entered. This request is received by the user connected to the Eyezon service, thus, even before the start of the live video broadcasting, the one who will show it, has maximum information about the object or place the site user is interested in. A person responding to the request with a live video broadcast can perform it from any geographical point.

The individual live video broadcast is displayed in the same pop-up window where the site user has submitted the request. Therefore, for the user, the switching from the visual or text description of the object or place to the direct individual video broadcast occurs on the same page of the site where he is staying. In the same pop-up window displaying the live broadcast, the site user has the opportunity to ask clarifying questions using text or audio messages without using third-party video, audio or text messaging services or tools. After completing the live video broadcasting, the site user can close the pop-up window and continue his actions on the site page where he was staying all this time.

As illustrated in FIG. 12, in one embodiment of the present invention, at step 201, on the Client device, Client or user entered the website/mobile application of the store. At step 203, Client presses Eyezon button on the website/mobile application of the store. At step 205, the Client has asked his (her) question. At step 207, Client has closed the Eyezon window. If Client has not closed the Eyezon window, then at step 209, Seller received notification with Client's question through Eyezon. At step 211, Seller answered the question immediately with photo/video, audio or live broadcast. At step 213, Client or Buyer received answer to the question in real-time mode on the site/mobile application of the store.

If Client has closed the Eyezon window at step 207 and Client turned PUSH notification on and gave email address, then, at step 215 in FIG. 12C, Seller received notification with Client question through Eyezon service. If the Seller is available, at step 217 Seller answered the question immediately with photo/video, audio or live broadcast. Then at step 219, Client received notification and email letter about Seller's answer. If Client got back to the request window in step 221, then at step 223 Client received answer to the question in real-time mode on the site/mobile application of the store.

Going back to step 215, if the Seller is not available and did not answer the question immediately with photo/video, audio or live broadcast in step 217, then at step 225, Client left the site. At step 227, when the Seller has replied, Client will receive notification and email letter about answer for getting back to the site/application. If Client got back to the site/application in step 229, then in step 231, Client received answer to the question in real-time mode on the site/mobile application of the store. If Client did not get back to the site/application in step 229, then in step 231, Client received answer to the question by email in the form of recorded video, audio or photo.

If Client has closed the Eyezon window at step 207 and Client turned PUSH notification on but did not give email address, then, at step 235 in FIG. 12A, Seller received notification with Client question through Eyezon service. If the Seller is available, at step 237 Seller answered the question immediately with photo/video, audio or live broadcast. Then at step 239, Client received notification about Seller's answer. If Client got back to the request window in step 241, then at step 243 Client received answer to the question in real-time mode on the site/mobile application of the store.

Going back to step 237, if the Seller is not available and did not answer the question immediately with photo/video, audio or live broadcast in step 237, then at step 245, Client left the site. At step 247, when the Seller has replied, Client will receive notification and email letter about answer for getting back to the site/application. If Client got back to the site/mobile application in step 249, then in step 251, Client received answer to the question in real-time mode on the site/mobile application of the store.

If Client has closed the Eyezon window at step 207 and Client did not turn PUSH notification on and did not give email address, then, at step 253 in FIG. 12B, Seller received notification with Client question through Eyezon service. If the Seller is available, at step 255 Seller answered the question immediately with photo/video, audio or live broadcast. Then then at step 257, Client received answer to the question in real-time mode on the site/mobile application of the store. Otherwise, at step 259 Client left the site.

We claim:

1. A method for providing information comprising:
Entering on a user device a setup request on a webpage associated with a product;
Receiving the setup request regarding the product at a server;
Searching a database for streamers for the product wherein the database includes at least one streamer who is a previous purchaser of the product;
Identifying the at least one streamer for the product who is a previous purchaser of the product;
Providing to the user an interface for entering a request for information;
Entering a request for information regarding the product through the interface;
Sending the request for information to the server;
Receiving the request for information by the server;
Forwarding the request for information to the at least one streamer for the product;
Receiving the request for information on a device of the at least one streamer for the product;
Receiving a decision from the at least one streamer for the product whether to accept or reject the request for information;
If the at least one streamer for the product accepts the request for information, processing the request for information, receiving a selection of a live broadcast option from the at least one streamer for the product, turning on a camera on the device of the at least one streamer for the product, sending a request for a live broadcast channel from the server to a broadcast server, establishing the live broadcast channel by the broadcast server, transmitting a link to the live broadcast channel to the server from the broadcast server, transmitting the link to the live broadcast channel to the user device from the server, connecting the user device to the live broadcast channel through the link; establishing video and audio communication between the user and the at least one streamer for the product through the live broadcast channel; receiving an array of cursor coordinates corresponding to a position of an object drawn by the user on a screen of the user device.

2. The method of claim 1, wherein entering on a user device a setup request on a webpage associated with a product comprises pressing a button on the webpage.

3. The method of claim 1, wherein entering a request for information comprises pressing a button on the webpage.

4. The method of claim 1, wherein the product comprises a service.

5. The method of claim 1, wherein the webpage associated with a product comprises a mobile application page.

6. The method of claim 1, wherein the live broadcast channel between the user and the at least one streamer for the product is capable to communicate at least one of photo files, audio files, video files, or live audio and video broadcasting.

7. The method of claim 1, wherein the connecting the user device to the live broadcast channel through the link comprises opening up a new browser window on the user device.

8. The method of claim 7, wherein the connecting the user device to the live broadcast channel through the link further comprises turning on a camera and microphone on the user device.

9. The method of claim 1, wherein the request for information comprises a text message, an email, or an SMS message.

10. The method of claim 1, wherein the request for information comprises a request for advice.

11. The method of claim 1, wherein the webpage associated with a product is a webpage of an online store.

12. The method of claim 1, wherein the receiving the request for information on a device of the at least one streamer for the product comprises receiving a push notification on a device of the at least one streamer for the product.

13. The method of claim 1, further comprising turning push notification on the user device and providing email address of the user.

14. The method of claim 1, further comprising turning push notification on the user device.

15. The method of claim 1, wherein the interface for entering a request for information comprises a pop-up window.

16. The method of claim 1, wherein the interface for entering a request for information comprises a text or audio communication channel.

17. The method of claim 1, wherein the establishing video and audio communication between the user and the at least one streamer for the product through the live broadcast channel is performed in the interface.

18. The method of claim 1, further comprising receiving a response from the at least one streamer for the product to the information request via email message.

19. The method of claim 1, further comprising recording video and audio communications between the user and the at least one streamer for the product through the live broadcast channel.

20. The method of claim 1, further comprising an add-to-cart button placed in the live broadcast channel or the interface wherein both the user and the at least one streamer could click in order to purchase the product.

21. The method of claim 1, further comprising adding to the database a first streamer who is registered as a streamer with at least two separate sellers.

22. A system for providing information comprising:
A streaming server;
A database communicatively coupled to the streaming server; and
A server communicatively coupled to the streaming server, the server configured with a non-transitory computer readable medium having stored thereon computer instructions, which upon execution by a central processing engine, cause the central processing engine to execute one or more applications for providing information comprising:
Receiving at the server a setup request regarding a product on a webpage associated with the product entered on a user device;
Searching the database for streamers for the product wherein the database includes at least one streamer who is a previous purchaser of the product;
Identifying the at least one streamer for the product who is a previous purchaser of the product;
Providing to the user device an interface for entering a request for information;
Receiving by the server a request for information regarding the product entered on the user device through the interface;
Forwarding the request for information to the at least one streamer for the product;
Receiving the request for information on a device of the at least one streamer for the product;
Receiving a decision from the at least one streamer for the product whether to accept or reject the request for information;
If the at least one streamer for the product accepts the request for information, processing the request for information, receiving a selection of a live broadcast option from the at least one streamer for the product, turning on a camera on the device of the at least one streamer for the product, sending a request for a live broadcast channel from the server to the streaming server, establishing the live broadcast channel by the streaming server, transmitting a link to the live broadcast channel to the server from the streaming server, transmitting the link to the live broadcast channel to the user device from the server, connecting the user device to the live broadcast channel through the link; establishing video and audio communication between the user and the at least one streamer for the product through the live broadcast channel; receiving an array of cursor coordinates corresponding to a position of an object drawn by the user on a screen of the user device.

23. A method for providing information comprising:
Entering on a user device a setup request on a webpage associated with a product;
Receiving the setup request regarding the product at a server;
Searching a database for streamers for the product wherein the database includes at least one streamer who is a previous purchaser of the product;
Identifying the at least one streamer for the product who is a previous purchaser of the product;
Providing to the user an interface for entering a request for information;
Entering a request for information regarding the product through the interface, wherein the request for information comprises a request for a guest to join the user;
Sending the request for information to the server;
Receiving the request for information by the server;
Forwarding the request for information to the at least one streamer for the product;
Receiving the request for information on a device of the at least one streamer for the product;
Receiving a decision from the at least one streamer for the product whether to accept or reject the request for information;
If the at least one streamer for the product accepts the request for information, processing the request for information,
receiving a selection of a live broadcast option from the at least one streamer for the product, turning on a camera on the device of the at least one streamer for the product,
sending a request for a first and a second live broadcast channels from the server to a broadcast server, establishing the first and the second live broadcast channels by the broadcast server,
transmitting a first link to the first live broadcast channel to the server from the broadcast server,
transmitting a second link to the second live broadcast channel to the server from the broadcast server,
transmitting the first link to the first live broadcast channel to the user device from the server,
connecting the user device to the first live broadcast channel through the first link; establishing video and audio communication between the user and the at least one streamer for the product through the first live broadcast channel;
transmitting a second link to the second live broadcast channel to the user device from the server,
connecting a computing device of the guest to the second live broadcast channel through the second link,
establishing video and audio communication between the guest, the user and the at least one streamer for the product through the first live broadcast channel and the second live broadcast channel;
receiving an array of cursor coordinates corresponding to a position of an object drawn by the user on a screen of the user device.

24. A method for providing information comprising:
Providing to a user on a user device an interface for entering a request for information on a webpage associated with a product;
Obtaining user contact information comprising one or more of an email address, a phone number, a name, and a physical street address;
Entering a request for information regarding the product through the interface;
Sending the request for information to a server;
Receiving the request for information by the server;
Searching a database for streamers for the product wherein the database includes at least one streamer who is a previous purchaser of the product;
Identifying the at least one streamer for the product who is a previous purchaser of the product;
Forwarding the request for information to the at least one streamer for the product;
Receiving the request for information on a device of the at least one streamer for the product;
Receiving a decision from the at least one streamer for the product whether to accept or reject the request for information;
If the at least one streamer for the product accepts the request for information but the user closes the interface before a live broadcast channel with the at least one streamer was established,
recording a video presentation regarding the product by the at least one streamer for the product;
delivering the video presentation to the user by using the user contact information.

25. A method for providing information comprising:
Receiving a request for information regarding a product through a user scanning a QR-code by a user device;
Sending the request for information to a server;
Receiving the request for information by the server;
Searching a database for streamers for the product wherein the database includes at least one streamer who is a previous purchaser of the product;
Identifying the at least one streamer for the product who is a previous purchaser of the product;
Forwarding the request for information to the at least one streamer for the product;
Receiving the request for information on a device of the at least one streamer for the product;
Receiving a decision from the at least one streamer for the product whether to accept or reject the request for information;
If the at least one streamer for the product accepts the request for information, processing the request for information, receiving a selection of a live broadcast option from the at least one streamer for the product, turning on a camera on the device of the at least one streamer for the product, sending a request for a live broadcast channel from the server to the streaming server, establishing the live broadcast channel by the streaming server, transmitting a link to the live broadcast channel to the server from the streaming server, transmitting the link to the live broadcast channel to the user device from the server, connecting the user device to the live broadcast channel through the link; establishing video and audio communication between the user and the at least one streamer for the product through the live broadcast channel.

26. The method of claim 25, wherein the user scanning a QR-code by a user device further comprises scanning the QR-code placed in an advertisement, a video, a mobile application, a webpage, or a publication.

27. A method for providing information comprising:
Receiving a request for information from a user on a device of a streamer for a product;
Sending a decision from the streamer for the product whether to accept or reject the request for information;
If the streamer for the product accepts the request for information, sending a selection of a live broadcast option from the streamer for the product,
Conducting a video and audio communication between the user and the streamer for the product through a live broadcast channel.
